(19) United States
(12) Patent Application Publication
(10) Pub. No.: US 2024/0357556 A1
(43) Pub. Date: Oct. 24, 2024

(54) DATA TRANSMISSION OVER UPLINK TRANSMISSION RESOURCES SHARED BY A LARGE NUMBER OF USER EQUIPMENTS

(71) Applicant: QUALCOMM Incorporated, San Diego, CA (US)

(72) Inventors: Linhai HE, San Diego, CA (US); Jing LEI, San Diego, CA (US); Ruiming ZHENG, Beijing (CN)

(21) Appl. No.: 18/294,115

(22) PCT Filed: Sep. 30, 2021
(86) PCT No.: PCT/CN2021/122171

§ 371 Date: Jan. 31, 2024

(51) Int. Cl. H04W 72/04; H04W 72/232

(52) U.S. Cl. CPC H04W 72/04; H04W 72/232

(57) ABSTRACT

Methods, systems, and devices for wireless communications are described. In a wireless communications system, a first user equipment (UE) may use techniques to transmit data over a configured grant shared by multiple UEs. The first UE may receive a control message indicating a group identifier assigned to a group of UEs including the first UE, and indicating multiple up-link transmission resources allocated to the group. The first UE may transmit a message scrambled by the group identifier during a first uplink transmission, where the message may include a user equipment identifier of the first UE. In identifier or the user equipment identifier based on transmitting the message. If the response message includes the group identifier, the UE may retransmit the message until the response message includes the user equipment identifier.

### CROSS REFERENCE

The present application is a 371 national stage filing of International PCT Application No. PCT/CN2021/122171 by HE et al. entitled “DATA TRANSMISSION OVER UPLINK TRANSMISSION RESOURCES SHARED BY A LARGE NUMBER OF USER EQUIPMENTS,” filed Sep. 30, 2021, which is assigned to the assignee hereof, and which is expressly incorporated by reference in its entirety herein.

### FIELD OF TECHNOLOGY

The following relates to wireless communications, including data transmission over uplink transmission resources shared by a large number of user equipments (UEs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support data transmission over uplink transmission resources shared by a large number of user equipments (UEs). Generally, the described techniques provide for performing data transmissions over an uplink transmission resource shared by a large number of UEs. For example, a UE may be associated with a user equipment identifier, such as a cell-radio network temporary identifier (C-RNTI). The UE may receive a control message from a base station indicating a group identifier, such as a group-RNTI, which may be assigned to a group of UEs including the UE. The control message may also indicate a set of uplink transmission resources allocated to the group of UEs. In some examples, during a first uplink transmission resource, the UE may transmit a message to the base station including the user equipment identifier, where the message may be scrambled by the group identifier (e.g., that is shared by the group of UEs). The UE may receive a response message from the base station including either the group identifier or the user equipment identifier in response to transmitting the message. That is, if the base station successfully decoded the message (e.g., if the base station identified the UE in the group of UEs that transmitted the message), then the base station may transmit the response message including the user equipment identifier.

In some examples, the base station may be unable to identify which UE of the group of UEs transmitted the message, and as such the base station may transmit the response message including the group identifier. Upon receiving the response message from the base station including the group identifier, the UE may retransmit the message based on a list of uplink grants, a backoff indication, or both, which may be additionally included in the response message. The UE may retransmit the message until the base station identifies that the message was transmitted by the UE (e.g., until the response message includes the user equipment identifier). By having a group identifier in addition to a user equipment identifier, the UE may reduce signaling overhead and limit processing at the base station, and the base station may receive and attempt to decode fewer messages including group identifiers for a group of UEs rather than an individual message for each individual UE.

A method for wireless communication at a first UE is described. The method may include receiving a control message indicating a group identifier assigned to a group of UEs that includes the first UE and indicating a set of multiple uplink transmission resources allocated to the group of UEs, transmitting, during a first uplink transmission resource of the set of multiple uplink transmission resources, a first message scrambled by the group identifier, where the first message includes a user equipment identifier of the first UE, and receiving a first response message including one of the group identifier or the user equipment identifier in response to transmitting the first message.

An apparatus for wireless communication at a first UE is described. The apparatus may include a processor, memory coupled with the processor, and instructions stored in the memory. The instructions may be executable by the processor to cause the apparatus to receive a control message indicating a group identifier assigned to a group of UEs that includes the first UE and indicating a set of multiple uplink transmission resources allocated to the group of UEs, transmit, during a first uplink transmission resource of the set of multiple uplink transmission resources, a first message scrambled by the group identifier, where the first message includes a user equipment identifier of the first UE, and receive a first response message including one of the group identifier or the user equipment identifier in response to transmitting the first message.

Another apparatus for wireless communication at a first UE is described. The apparatus may include means for receiving a control message indicating a group identifier assigned to a group of UEs that includes the first UE and indicating a set of multiple uplink transmission resources allocated to the group of UEs, means for transmitting, during a first uplink transmission resource of the set of multiple uplink transmission resources, a first message scrambled by the group identifier, where the first message includes a user equipment identifier of the first UE, and means for receiving a first response message including one of the group identifier or the user equipment identifier in response to transmitting the first message.

A non-transitory computer-readable medium storing code for wireless communication at a first UE is described. The code may include instructions executable by a processor to receive a control message indicating a group identifier assigned to a group of UEs that includes the first UE and indicating a set of multiple uplink transmission resources allocated to the group of UEs, transmit, during a first uplink transmission resource of the set of multiple uplink transmission resources, a first message scrambled by the group identifier, where the first message includes a user equipment identifier of the first UE, and receive a first response message including one of the group identifier or the user equipment identifier in response to transmitting the first message.

In some examples of the method, apparatuses, and non-transitory computer-readable medium described herein, receiving the first response message may include operations, features, means, or instructions for receiving, via downlink control information (DCI), the first response message scrambled by the user equipment identifier in response to transmitting the first message.

In some examples of the method, apparatuses, and non-transitory computer-readable medium described herein, receiving the first response message may include operations, features, means, or instructions for receiving, via a shared channel, the first response message scrambled by the group identifier in response to transmitting the first message.

Some examples of the method, apparatuses, and non-transitory computer-readable medium described herein may further include operations, features, means, or instructions for transmitting a second message that may be a retransmission of the first message based on receiving the first response message via the shared channel, the second message being scrambled by the group identifier and including the user equipment identifier of the first UE and receiving, via DCI, a second response message in response to transmitting the second message.

In some examples of the method, apparatuses, and non-transitory computer-readable medium described herein, receiving the first response message may include operations, features, means, or instructions for receiving, via a shared channel, the first response message including the group identifier, a set of multiple uplink grants, a backoff indication, or any combination thereof.

In some examples of the method, apparatuses, and non-transitory computer-readable medium described herein, receiving the first response message may include operations, features, means, or instructions for receiving, via a shared channel, the first response message including the group identifier and a set of multiple uplink grants and transmitting, during a first resource allocated by a first grant of the set of multiple uplink grants selected based on the user equipment identifier and a quantity of the set of multiple uplink grants, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier and a set of multiple uplink grants and transmitting, during a first resource allocated by a randomly selected grant of the set of multiple uplink grants, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier and transmitting, during a second uplink transmission resource of the set of multiple uplink transmission resources, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier and a backoff indication, where the backoff indication indicates a first set of one or more uplink transmission resources of the set of multiple uplink transmission resources to refrain from transmitting and transmitting, during a second uplink transmission resource of the set of multiple uplink transmission resources in accordance with the backoff indication, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier and a backoff indication, where the backoff indication includes a codepoint to a table of backoff intervals and transmitting, during a second uplink transmission resource of the set of multiple uplink transmission resources corresponding to a backoff interval from the table associated with the codepoint, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier, a set of multiple uplink grants, and a backoff indication and transmitting, during a resource allocated by a first uplink grant or in accordance with the backoff indication indicating to refrain from transmitting in at least one uplink transmission resource of the set of multiple uplink transmission resources, a second message that may be a retransmission of the first message, the second message scrambled by the group identifier and including the user equipment identifier of the first UE.

Some examples of the method, apparatuses, and non-transitory computer-readable medium described herein may further include operations, features, means, or instructions for receiving the control message indicating a search space including a set of multiple control channel candidates, monitoring the search space for the first response message, and receiving the first response message in a first control channel candidate of the set of multiple control channel candidates based on the monitoring.

In some examples of the method, apparatuses, and non-transitory computer-readable medium described herein, transmitting the first message may include operations, features, means, or instructions for transmitting, in a medium access control (MAC) control element (MAC-CE), the user equipment identifier, where the first UE may be in a connected state or an inactive state.

In some examples of the method, apparatuses, and non-transitory computer-readable medium described herein, transmitting the first message may include operations, features, means, or instructions for transmitting, in a MAC-CE, the first message, where the user equipment identifier of the first UE may be derived based on a hash of a longer device identifier, and where the first UE may be in an idle state.

In some examples of the method, apparatuses, and non-transitory computer-readable medium described herein, the group identifier corresponds to a group-RNTI and the user equipment identifier corresponds to a C-RNTI.

A method for wireless communication at a base station is described. The method may include transmitting a control message indicating a group identifier assigned to a group of UEs that includes a first UE and indicating a set of multiple uplink transmission resources allocated to the group of UEs, receiving, from the first UE and during a first uplink transmission resource of the set of multiple uplink transmission resources, a first message scrambled by the group identifier, and transmitting, to the first UE, a first response message including one of the group identifier or a user equipment identifier indicated in the first message in response to transmitting the first message.

An apparatus for wireless communication at a base station is described. The apparatus may include a processor, memory coupled with the processor, and instructions stored in the memory. The instructions may be executable by the processor to cause the apparatus to transmit a control message indicating a group identifier assigned to a group of UEs that includes a first UE and indicating a set of multiple uplink transmission resources allocated to the group of UEs, receive, from the first UE and during a first uplink transmission resource of the set of multiple uplink transmission resources, a first message scrambled by the group identifier, and transmit, to the first UE, a first response message including one of the group identifier or a user equipment identifier indicated in the first message in response to transmitting the first message.

Another apparatus for wireless communication at a base station is described. The apparatus may include means for transmitting a control message indicating a group identifier assigned to a group of UEs that includes a first UE and indicating a set of multiple uplink transmission resources allocated to the group of UEs, means for receiving, from the first UE and during a first uplink transmission resource of the set of multiple uplink transmission resources, a first message scrambled by the group identifier, and means for transmitting, to the first UE, a first response message including one of the group identifier or a user equipment identifier indicated in the first message in response to transmitting the first message.

A non-transitory computer-readable medium storing code for wireless communication at a base station is described. The code may include instructions executable by a processor to transmit a control message indicating a group identifier assigned to a group of UEs that includes a first UE and indicating a set of multiple uplink transmission resources allocated to the group of UEs, receive, from the first UE and during a first uplink transmission resource of the set of multiple uplink transmission resources, a first message scrambled by the group identifier, and transmit, to the first UE, a first response message including one of the group identifier or a user equipment identifier indicated in the first message in response to transmitting the first message.

In some examples of the method, apparatuses, and non-transitory computer-readable medium described herein, transmitting the first response message may include operations, features, means, or instructions for transmitting, via DCI, the first response message scrambled by the user equipment identifier in response to receiving the first message.

In some examples of the method, apparatuses, and non-transitory computer-readable medium described herein, transmitting the first response message may include operations, features, means, or instructions for transmitting, via a shared channel, the first response message scrambled by the group identifier in response to receiving the first message.

Some examples of the method, apparatuses, and non-transitory computer-readable medium described herein may further include operations, features, means, or instructions for receiving a second message that may be a retransmission of the first message based on transmitting the first response message via the shared channel, the second message being scrambled by the group identifier and including the user equipment identifier of the first UE and transmitting, via DCI, a second response message in response to receiving the second message.

In some examples of the method, apparatuses, and non-transitory computer-readable medium described herein, transmitting the first response message may include operations, features, means, or instructions for transmitting, via a shared channel, the first response message including the group identifier, a set of multiple uplink grants, a backoff indication or any combination thereof.

In some examples of the method, apparatuses, and non-transitory computer-readable medium described herein, transmitting the first response message may include operations, features, means, or instructions for transmitting, via a shared channel, the first response message including the group identifier and a set of multiple uplink grants and receiving, during a first resource allocated by a first grant of the set of multiple uplink grants selected based on the user equipment identifier and a quantity of the set of multiple uplink grants, a second message that may be a retransmission of the first message, the second message scrambled by the group identifier and including the user equipment identifier of the first UE.

In some examples of the method, apparatuses, and non-transitory computer-readable medium described herein, transmitting the first response message may include operations, features, means, or instructions for transmitting, via a shared channel, the first response message including the group identifier and a set of multiple uplink grants and receiving, during a first resource allocated by a randomly selected grant of the set of multiple uplink grants, a second message that may be a retransmission of the first message, the second message scrambled by the group identifier and including the user equipment identifier of the first UE.

In some examples of the method, apparatuses, and non-transitory computer-readable medium described herein, transmitting the first response message may include operations, features, means, or instructions for transmitting, via a shared channel, the first response message including the group identifier and receiving, during a second uplink transmission resource of the set of multiple uplink transmission resources, a second message that may be a retransmission of the first message, the second message scrambled by the group identifier and including the user equipment identifier of the first UE.

In some examples of the method, apparatuses, and non-transitory computer-readable medium described herein, transmitting the first response message may include operations, features, means, or instructions for transmitting, via a shared channel, the first response message including the group identifier and a backoff indication, where the backoff indication indicates a first set of one or uplink transmission resources of the set of multiple uplink transmission resources to refrain from transmitting and receiving, during a second uplink transmission resource of the set of multiple uplink transmission resources in accordance with the backoff indication, a second message that may be a retransmission of the first message, the second message scrambled by the group identifier and including the user equipment identifier of the first UE.

In some examples of the method, apparatuses, and non-transitory computer-readable medium described herein, transmitting the first response message may include operations, features, means, or instructions for transmitting, via a shared channel, the first response message including the group identifier and a backoff indication, where the backoff indication includes a codepoint to a table of backoff intervals and receiving, during a second uplink transmission resource of the set of multiple uplink transmission resources corresponding to a backoff interval from the table associated with the codepoint, a second message that may be a retransmission of the first message, the second message scrambled by the group identifier and including the user equipment identifier of the first UE.

In some examples of the method, apparatuses, and non-transitory computer-readable medium described herein, receiving the first response message may include operations, features, means, or instructions for receiving, via a shared channel, the first response message including the group identifier, a set of multiple uplink grants, and a backoff indication and transmitting, during a resource allocated by a first uplink grant or in accordance with the backoff indication indicating to refrain from transmitting in at least one uplink transmission resource of the set of multiple uplink transmission resources, a second message that may be a retransmission of the first message, the second message scrambled by the group identifier and including the user equipment identifier of the first UE.

Some examples of the method, apparatuses, and non-transitory computer-readable medium described herein may further include operations, features, means, or instructions for transmitting the control message indicating a search space including a set of multiple control channel candidates and transmitting the first response message in a first control channel candidate of the set of multiple control channel candidates based on transmitting the control message.

In some examples of the method, apparatuses, and non-transitory computer-readable medium described herein, receiving the first message may include operations, features, means, or instructions for receiving, in a MAC-CE, the user equipment identifier, where the first UE may be in a connected state or an inactive state.

In some examples of the method, apparatuses, and non-transitory computer-readable medium described herein, receiving the first message may include operations, features, means, or instructions for receiving, in a MAC-CE, the first message, where the user equipment identifier of the first UE may be derived based on a hash of a longer device identifier, and where the first UE may be in an idle state.

In some examples of the method, apparatuses, and non-transitory computer-readable medium described herein, the group identifier corresponds to a group-RNTI and the user equipment identifier corresponds to a C-RNTI.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports data transmission over uplink transmission resources shared by a large number of UEs in accordance with aspects of the present disclosure.

FIG. 2 illustrates an example of a wireless communications system that supports data transmission over uplink transmission resources shared by a large number of UEs in accordance with aspects of the present disclosure.

FIGS. 3 and 4 illustrate examples of timelines that support data transmission over uplink transmission resources shared by a large number of UEs in accordance with aspects of the present disclosure.

FIGS. 5 and 6 illustrate examples of process flows that support data transmission over uplink transmission resources shared by a large number of UEs in accordance with aspects of the present disclosure.

FIGS. 7 and 8 show block diagrams of devices that support data transmission over uplink transmission resources shared by a large number of UEs in accordance with aspects of the present disclosure.

FIG. 9 shows a block diagram of a communications manager that supports data transmission over uplink transmission resources shared by a large number of UEs in accordance with aspects of the present disclosure.

FIG. 10 shows a diagram of a system including a device that supports data transmission over uplink transmission resources shared by a large number of UEs in accordance with aspects of the present disclosure.

FIGS. 11 and 12 show block diagrams of devices that support data transmission over uplink transmission resources shared by a large number of UEs in accordance with aspects of the present disclosure.

FIG. 13 shows a block diagram of a communications manager that supports data transmission over uplink transmission resources shared by a large number of UEs in accordance with aspects of the present disclosure.

FIG. 14 shows a diagram of a system including a device that supports data transmission over uplink transmission resources shared by a large number of UEs in accordance with aspects of the present disclosure.

FIGS. 15 through 20 show flowcharts illustrating methods that support data transmission over uplink transmission resources shared by a large number of UEs in accordance with aspects of the present disclosure.

### DETAILED DESCRIPTION

In some wireless communications systems, multiple user equipments (UEs) may share a configured grant (CG) (e.g., a type-1 CG). For example, a CG may be activated immediately after configuration of the UE (e.g., radio resource control (RRC) configuration), which may enable the CG to be shared by multiple UEs. In some cases, however, a CG may lack the ability to support a large number of UEs that share the same resources. For example, transmissions over a CG may use extensive processing at a base station if a large number of UEs share the CG. In addition, if many UEs simultaneously transmit over the same CG occasion, and if the UEs autonomously retransmit messages over a next available CG occasion, the wireless communication system may lack techniques to mitigate the congestion.

Techniques described herein enable a UE to perform data transmissions over an uplink transmission resource (e.g., a CG) shared by a large number of UEs. For example, a UE may be associated with a user equipment identifier, such as a cell-radio network temporary identifier (C-RNTI). The UE may receive a control message from a base station indicating a group identifier, such as a group-RNTI, which may be assigned to a group of UEs including the UE. The control message may also indicate a set of uplink transmission resources (e.g., CG occasions) allocated to the group of UEs. In some examples, during a first uplink transmission resource, the UE may transmit a message to the base station including the user equipment identifier, where the message may be scrambled by the group identifier (e.g., that is shared by the group of UEs). The UE may receive a response message from the base station including either the group identifier or the user equipment identifier in response to transmitting the message. That is, if the base station successfully decoded the message (e.g., if the base station identified the UE in the group of UEs that transmitted the message), then the base station may transmit the response message including the user equipment identifier.

In some examples, the base station may be unable to identify which UE of the group of UEs transmitted the message, and as such the base station may transmit the response message including the group identifier. Upon receiving the response message from the base station including the group identifier, the UE may retransmit the message based on a list of uplink grants, a backoff indication, or both, which may be additionally included in the response message. The UE may retransmit the message until the base station identifies that the message was transmitted by the UE (e.g., until the response message includes the user equipment identifier). By having a group identifier in addition to a user equipment identifier, the UE may reduce signaling overhead and limit processing at the base station, and the base station may receive and attempt to decode fewer messages including group identifiers for a group of UEs rather than an individual message for each individual UE.

Aspects of the disclosure are initially described in the context of wireless communications systems. Aspects of the disclosure are then described in the context of timelines and process flow diagrams. Aspects of the disclosure are further illustrated by and described with reference to apparatus diagrams, system diagrams, and flowcharts that relate to data transmission over uplink transmission resources shared by a large number of UEs.

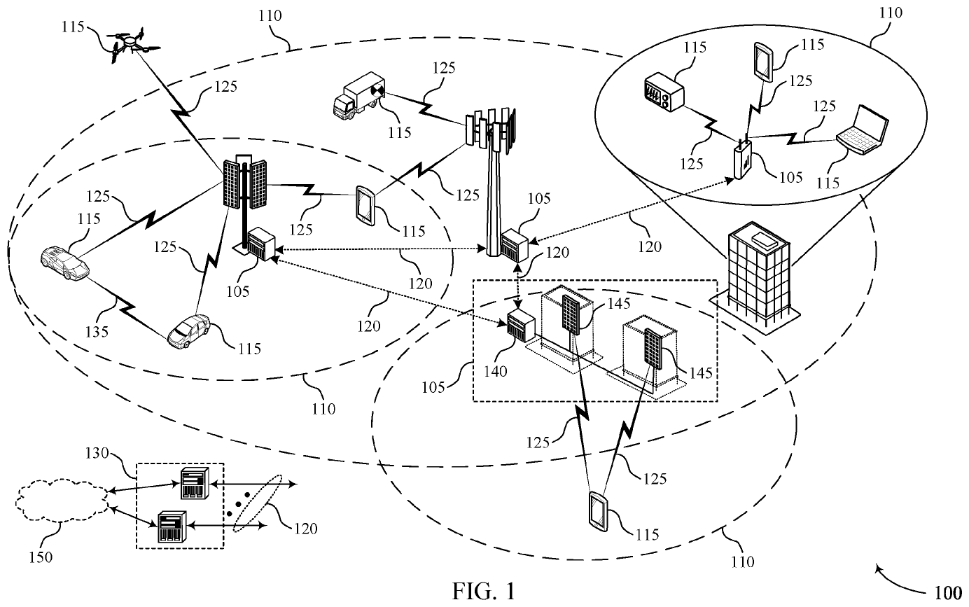

FIG. 1 illustrates an example of a wireless communications system 100 that supports data transmission over uplink transmission resources shared by a large number of UEs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a ULE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may communicate using an enhanced CG (e.g., a type-1 CG), which may be activated immediately after configuration of the UE 115 (e.g., RRC configuration). This way of activation may enable multiple UEs 115 to share the CG. In some examples, the CG may be used for physical uplink shared channel (PUSCH) transmissions for UEs 115 in an inactive state (e.g., RRC inactive) or for UEs 115 in a connected state (e.g., RRC configured). For example, a UE 115 in an inactive state may use a CG for CG-based small data transfers without switching to a connected state. In some examples, the CG may be shared by a large number of UEs 115. For example, some UEs 115 may be used for low-power sensors (e.g., smart utility meters), and may be deployed in high density but may have a low traffic duty cycle (e.g., Superlight UEs). Configuring a CG for a small group of UEs 115 in such cases may be resource expensive as many CG occasions may be unused and thus may become wasted resources.

In some examples, an uplink transmission resource (e.g., a CG) may be unable to efficiently support a large number if UEs 115 that may share the same resources. For example, a UE 115 may transmit a message over an uplink transmission resource, where the message may be scrambled by a UE-specific RNTI (e.g., a user equipment identifier). A large number of UEs 115 sharing the same uplink transmission resource and each transmitting messages scrambled by different UE-specific RNTIs may cause additional processing at the base station, which may be unscalable. In addition, if there are many UEs 115 simultaneously transmitting messages over the same uplink transmission resource, the wireless communications system 100 may lack techniques to mitigate the congestion as the UEs 115 may autonomously retransmit the messages over a next available uplink transmission resource if a first transmission is unsuccessful (e.g., if the base station 105 is unable to decode the transmission).

The wireless communications system 100 may support techniques for performing data transmissions over an uplink transmission resource shared by a large number of UEs 115. The described techniques may support UEs 115 in multiple RRC states, including a connected state (e.g., RRC connected), an inactive state (e.g., RRC inactive), an idle state (e.g., RRC idle), or any combination thereof. For example, the described techniques may support UEs 115 performing contention-based, CG small data transfers, UEs 115 with relaxed latency requirements (e.g., Superlight UEs), and any other UEs in an RRC state. In some examples, a UE 115 may be associated with a user equipment identifier, such as a C-RNTI. The UE 115 may receive a control message from a base station 105 indicating a group identifier, such as a group-RNTI, that may be assigned to a group of UEs including the UE 115. The group of UEs may share the uplink transmission resource, and as such, the control message may also indicate a set of uplink transmission resources (e.g., CG occasions) allocated to the group of UEs.

In some examples, during a first uplink transmission resource, the UE 115 may transmit a message to the base station 105 that may include the user equipment identifier, where the message may be scrambled by the group identifier (e.g., that is shared by the group of UEs). The UE 115 may receive a response message from the base station 105 that may include either the group identifier or the user equipment identifier in response to transmitting the message. That is, if the base station 105 successfully decoded the message (e.g., if the base station 105 identified the UE 115 in the group of UEs 115 that transmitted the message), then the base station may transmit the response message including the user equipment identifier.

In some examples, the base station 105 may be unable to identify which UE 115 of the group of UEs transmitted the message, and as such the base station 105 may transmit the response message including the group identifier. Upon receiving the response message from the base station 105 including the group identifier, the UE 115 may retransmit the message based on a list of uplink grants, a backoff indication, or both, which may be additionally included in the response message. The UE 115 may retransmit the message until the base station 105 identifies that the message was transmitted by the UE 115 (e.g., until the response message includes the user equipment identifier).

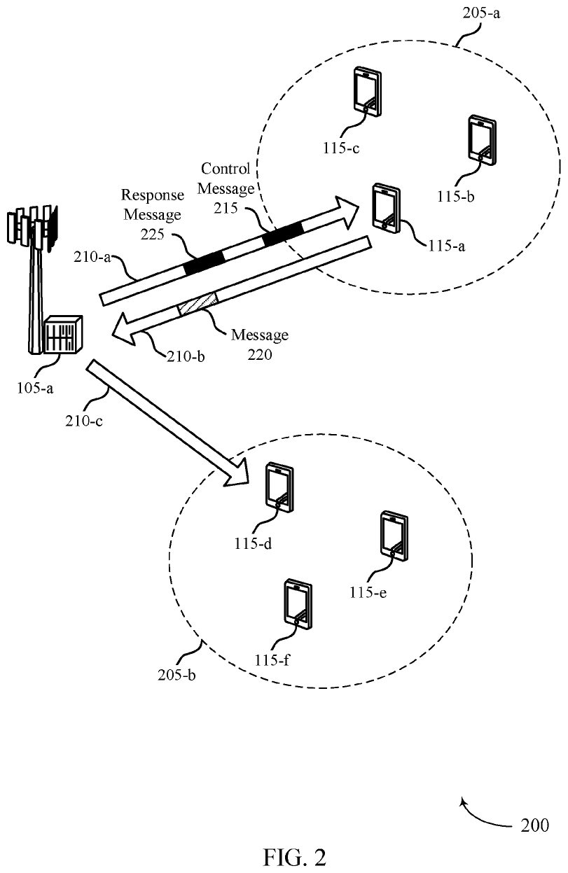

FIG. 2 illustrates an example of a wireless communications system 200 that supports data transmission over uplink transmission resources shared by a large number of UEs in accordance with aspects of the present disclosure. In some examples, the wireless communications system 200 may implement aspects of the wireless communications system 100 or may be implemented by aspects of the wireless communications system 100. For example, the wireless communications system 200 may include UEs 115 and a base station 105-a, which may be examples of corresponding devices described herein. The wireless communications system 200 may include features for improved communications between the UEs 115 and the base station 105-a.

The wireless communications system 200 may support multiple UEs 115, which may belong to one or more groups 205. For example, a group 205-a may include a UE 115-a, a UE 115-b, and a UE 115-c, and a group 205-b may include a UE 115-d, a UE 115-e, and a UE 115-f. In some cases, each UE 115 and each group 205 may be associated with a unique identifier. For example, the UE 115-a may be associated with a user equipment identifier specific to the UE 115-a (e.g., a C-RNTI), and the group 205-a may be associated with a group identifier specific to the group 205-a (e.g., a group-RNTI), where all of the UEs 115 in the group 205-a may share the group identifier.

The base station 105-a may communicate with the UEs 115 via communications links 210. For example, the base station 105-a may transmit signaling to the UE 115-a via a communications link 210-a (e.g., downlink) and receive communications from the UE 115-a via a communications link 210-b (e.g., uplink). Additionally or alternatively, the base station 105-a may communicate with the UE 115-d (e.g., or any other UE 115) via a communications link 210-c. The UE 115-a may transmit a message (e.g., PUSCH) to the base station 105-a over an uplink transmission resource, where the transmission may be scrambled by a common identifier (e.g., a common RNTI, eCG-RNTI). In some cases, the uplink transmission resource may be semi-persistently scheduled (e.g., a CG).

The UE 115-a may use an RNTI to scramble its MAC protocol data unit (PDU) when transmitting a message over an uplink transmission resource shared by other UEs 115. The common identifier may be associated with the group 205, and which may be shared by the other UEs 115. As such, the UE 115-a, the UE 115-b, and the UE 115-c may share the common identifier associated with the group 205-a. In some cases, the UEs 115 in the group 205-a may not be the full set of UEs 115 sharing the uplink transmission resource, and as such, some UEs 115 sharing the same uplink transmission resource may be associated with the same common identifier or different common identifiers. Based on the common identifier, the base station 105-a may decode fewer transmissions it may receive from one or more UEs 115.

In some case, the base station 105-a may be unable to identify which UE 115 in a group 205 transmitted a message based on the common identifier alone. As such, each UE 115 may indicate its identity using unique user equipment identifiers in its respective MAC PDUs. For example, a UE 115 in a connected state or an inactive state (e.g., RRC connected, RRC inactive) may include its user equipment identifier as a C-RNTI in a MAC-CE, and a UE 115 in an idle state (e.g., RRC idle) may include its user equipment identifier as a C-RNTI (e.g., 16 bits) which may derived, by hashing, from a corresponding UE identifier (e.g., 48 bits, such as TSMEI), in a MAC-CE. For example, the UE 115 may be assigned a hash function which may be used to transform the larger UE identifier (e.g., 48-bit identifier) into the user equipment identifier (e.g., 16-bit C-RNTI). For example, the hash function may a mathematical function that maps data of an arbitrary size to a fixed-size value (e.g., maps 48 bits to 16 bits), and the fixed-size value output from the hash function may be referred to as a hash. In some examples, the hash function may be a mathematical function that converts an input of arbitrary length into an encrypted output of a fixed length. Hashing may refer to the transformation of a string of characters or bits into a usually shorter fixed-length value or key that represents the original string.

The wireless communications system 200 may support techniques for performing data transmissions over an uplink transmission resource shared by a large number of UEs 115. In some cases, the UE 115-a may receive a control message 215 from the base station 105-a indicating a group identifier (e.g., a group-RNTI), that may be assigned to the group 205-a including the UE 115-a, the UE 115-b, and the UE 115-c. The UEs 115 in the group 205-a may share the uplink transmission resources, and as such, the control message may also indicate a set of uplink transmission resources (e.g., CG occasions) allocated to the group 205-a. In some examples, during a first uplink transmission resource, the UE 115-a may transmit a message 220 to the base station 105-a including the user equipment identifier, where the message 220 may be scrambled by the group identifier (e.g., that is shared by the UEs 115 in the group 205-a).

In response to transmitting the message 220, the UE 115-a may receive a response message 225 from the base station 105-a including either the group identifier or the user equipment identifier. In some cases, the base station 105-a may configure the UE 115-a with a search space in which the UE 115-a may monitor for the response message 225 from the base station 105-a. For example, the UE 115-a may receive the control message 215 indicating the search space, which may include multiple control channel candidates. The UE 115-a may monitor the control channel candidates of the search space for the response message 225, and may receive the response message 225 in a first control channel candidate based on monitoring for the response message 225. In some cases, the UE 115-a may monitor the search space for the response message 225 addressed to either the user equipment identifier or the group identifier. For example, the UE 115-a may receive the response message 225 including the user equipment identifier (e.g., C-RNTI). The UE 115-a may receive downlink control information (DCI) (e.g., a scheduling DCI) addressed to the user equipment identifier (e.g., which the UE 115-a included in its MAC PDU), and the transmission may be complete. That is, the transmission may be successfully decoded as the base station 105-a may have correctly identified that the UE 115-a sent the message 220 based on the user equipment identifier. In some examples, the UE 115-a may receive the response message 225 including the group identifier (e.g., eCG-RNTI), indicating that the base station 105-a was unable to decode the message 220. The UE 115-a may receive a physical downlink shared channel (PDSCH) addressed to its group identifier, indicating that the base station 105-a may have failed to identify which UE 115 of the group 205-a sent the message 220 based on the group identifier.

The response message 225 in the PDSCH addressed to the group identifier may include the group identifier, an optional list of uplink grants, an optional backoff indication, or any combination thereof. Based on receiving the response message 225 in the PDSCH, the UE 115-a may perform a retransmission of the message 220 according to a list of uplink grants, a backoff indication, or both. The UE 115-a may perform the retransmission until the base station 105-a identifies that the message was transmitted by the UE 115-a (e.g., until the response message 225 includes the user equipment identifier).

In some examples, the UE 115-a may receive the response message 225 including the group identifier and a list of uplink grants. The UE 115-a may select an uplink grant from the list of uplink grants based on the user equipment identifier and a quantity of uplink grants in the list (e.g., by hashing the user equipment identifier). For example, if there are N uplink grants, the UE 115-a may select the k^{th} uplink grant to perform the retransmission (e.g., if mod(C-RNTI, N)=k). Alternatively, or additionally, the UE 115-a may randomly select a grant from the list of uplink grants to perform the retransmission. For example, the UE 115-a may generate a random number p. that is uniformly distributed in the range [0, N]. If p. >0, then the UE 115-a may select the p^{th} uplink grant to perform the retransmission. Otherwise (e.g., if p. =0), then the UE 115-a may wait until the next uplink transmission resource (e.g., the next CG occasion) to perform the retransmission.

In some cases, the response message 225 may include the group identifier and a backoff indication. The backoff indication may indicate a first set of one or more uplink transmission resources to refrain from transmitting (e.g., skip) for the retransmission of the message 220. For example, a backoff indication may be an integer (e.g., denoted as B). The UE 115-a may generate a random number m that may be uniformly distributed between 0 and B−1. The UE 115-a may skip the next m number of uplink transmission resources (e.g., next m number of CG occasions) before the UE 115-a may retransmit the message 220 over an uplink transmission resource. In some cases, the backoff indication may be a codepoint to a table of backoff intervals. For example, the UE 115-a may use the backoff indication (e.g., a codepoint) to look up a backoff interval m from the table. For example, the table may include a set of multiple backoff intervals each associated with a different value of a codepoint, and the UE 115-a may index the table using the codepoint indicated by the backoff indication to identify which of the multiple backoff intervals listed in the table to use. The UE 115-a may skip the next m number of uplink transmission resources before it may retransmit the message 220 over an uplink transmission resource. In some examples, the backoff interval may be zero. In some cases, the table of backoff intervals may be predefined.

In some examples, the UE 115-a may receive the response message 225 in a PDSCH which may include a group identifier, a list of uplink grants, and a backoff indication. The UE 115-a may first determine whether to skip (e.g., refrain from transmitting) the next m number of uplink transmission resources. For example, the backoff indication may randomly indicate a set of one or more uplink transmission resources to skip, or the backoff indication may include a codepoint to a table of backoff intervals indicating how many m uplink transmission resources the UE 115-a may skip. After skipping one or more uplink transmission resources in accordance with the backoff indication, the UE 115-a select an uplink grant based on hashing its user equipment identifier (e.g., UE selects the kth uplink grant to perform retransmission, if mod(C-RNTI, N)=k), or the UE 115-a may randomly select an uplink grant. If the backoff indication indicates for the UE 115-a to skip zero uplink transmission resources (e.g., if m=0), then the UE 115-a may select an uplink grant from the list of uplink grants to perform the retransmission as described herein. For example, the UE 115-a may select an uplink grant based on hashing its user equipment identifier (e.g., UE selects the kth uplink grant to perform retransmission, if mod(C-RNTI, N)=k), or the UE 115-a may randomly select an uplink grant.

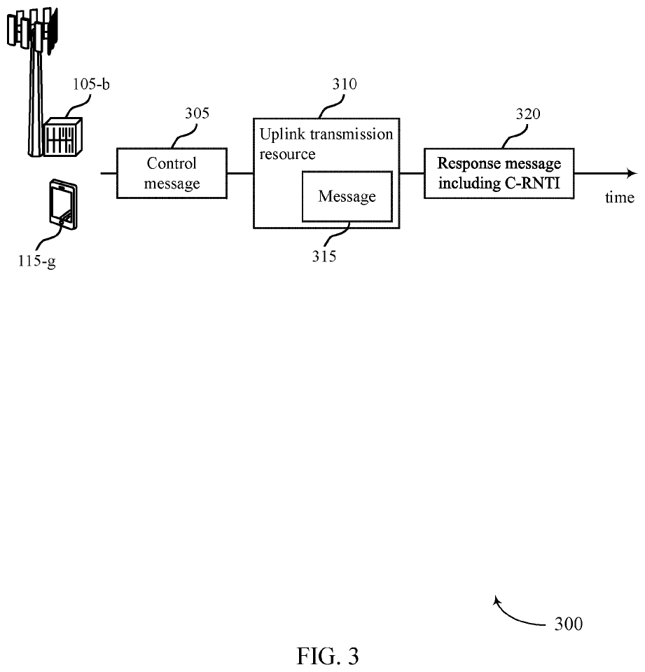

FIG. 3 illustrates an example of a timeline 300 that supports data transmission over uplink transmission resources shared by a large number of UEs in accordance with aspects of the present disclosure. In some examples, the timeline 300 may implement aspects of the wireless communications systems 100 and 200 or may be implemented by aspects of the wireless communications systems 100 and 200.

As described herein, a UE 115-g may perform data transmission over an uplink transmission resource (e.g., a configured grant) shared by a large number of UEs 115. In some cases, the UE 115-g may receive a control message 305 from the base station 105-b. The control message 305 may indicate a group identifier (e.g., a group-RNTI) assigned to a group of UEs including the UE 115-g and may indicate multiple uplink transmission resources allocated to the group of UEs. In some cases, the control message 305 may include a search space including multiple control channel candidates in which the UE 115-g may monitor for transmissions from the base station 105-b.

During an uplink transmission resource 310, the UE 115-g may transmit a message 315 scrambled by the group identifier, where the message 315 may include a user equipment identifier (e.g., a C-RNTI) corresponding to the UE 115-g. That is, the UE 115-g may be associated with the group identifier and the user equipment identifier, where both identifiers may be included (e.g., scrambled) in the message 315. In response to transmitting the message 315, the UE 115-g may receive a response message 320 from the base station 105-c. The response message 320 may include (e.g., may be scrambled by) the user equipment identifier, and may be transmitted in DCI. By including the user equipment identifier in the response message 320, the base station 105-b may indicate that it successfully decoded the message 315 and identified that the UE 115-g transmitted the message 315 (e.g., rather than another UE 115 associated with the same group identifier).

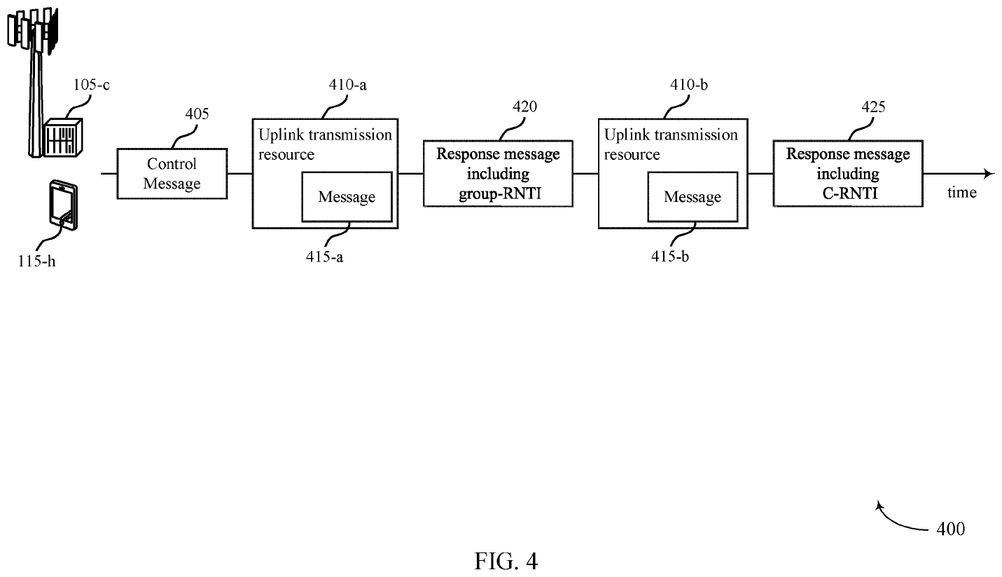

FIG. 4 illustrates an example of a timeline 400 that supports data transmission over uplink transmission resources shared by a large number of UEs in accordance with aspects of the present disclosure. In some examples, the timeline 400 may implement aspects of the wireless communications systems 100 and 200 or may be implemented by aspects of the wireless communications systems 100 and 200.

As described herein, a UE 115-h may perform data transmission over an uplink transmission resource (e.g., a configured grant) shared by a large number of UEs 115. In some cases, the UE 115-h may receive a control message 405 from the base station 105-c. The control message 405 may indicate a group identifier (e.g., a group-RNTI) assigned to a group of UEs including the UE 115-h, and may indicate multiple uplink transmission resources allocated to the group of UEs. In some cases, the control message 405 may include a search space including multiple control channel candidates in which the UE 115-h may monitor for transmissions from the base station 105-c.

During an uplink transmission resource 410-a, the UE 115-h may transmit a message 415-a scrambled by the group identifier, where the message 415-a may include a user equipment identifier (e.g., a C-RNTI) corresponding to the UE 115-h. That is, the UE 115-h may be associated with the group identifier and the user equipment identifier, where both identifiers may be included (e.g., scrambled) in the message 415-a. In response to transmitting the message 415-a, the UE 115-h may receive a response message 420 from the base station 105-c. The response message 420 may include (e.g., may be scrambled by) the group identifier, and may be transmitted in a PDSCH. By including the group identifier in the response message 420, the base station 105-c may indicate that it unsuccessfully decoded the message 415-a and was unable to identify which UE 115 in the group of UEs transmitted the message 415-a.

In some cases, the response message 420 may include the group identifier, a list of uplink grants, a backoff indication, or any combination thereof. The UE 115-h may transmit the message 415-b to the base station 105-c according to the list of uplink grants, the backoff indication, or both, where the message 415-b may be a retransmission of the message 415-a. For example, if the response message 420 includes the group identifier and a list of uplink grants, the UE 115-h may select an uplink grant from the list of uplink grants for transmitting the message 415-b. The UE 115-h may select the uplink grant based on hashing the user equipment identifier (e.g., based on the user equipment identifier and a quantity of uplink grants in the list of uplink grants), or the UE 115-h may randomly select an uplink grant, where the UE 115-h may wait until the randomly selected uplink grant to transmit the message 415-b. Additionally, or alternatively, the response message 420 may include the group identifier and a backoff indication. In some examples, the backoff indication may indicate a random number of uplink transmission resources the UE 115-h may skip (e.g., refrain from transmitting) before transmitting the message 415-b. In some cases, the backoff indication may include a codepoint to a table of backoff intervals, where the UE 115-g may skip a number of uplink transmission resources before transmitting the message 415-b indicated by the codepoint.

Based on a list of uplink grants, a backoff indication, or both, the UE 115-g may determine to transmit the message 415-b during an uplink transmission resource 410-b. In response to transmitting the message 415-b, the UE 115-g may receive a response message 425 from the base station 105-c. The response message 425 may include (e.g., may be scrambled by) the user equipment identifier, and may be transmitted in DCI. By including the user equipment identifier in the response message 425, the base station 105-c may indicate that it successfully decoded the message 415-b and identified that the UE 115-h transmitted the message 415-b (e.g., rather than another UE 115 associated with the same group identifier). In some examples, the response message 425 may include group identifier instead of the user equipment identifier as in the response message 420. In such cases, the UE 115-h may continue to transmit retransmissions of the message 415-a until the base station 105-c successfully decodes the message (e.g., until a response message includes the user equipment identifier).

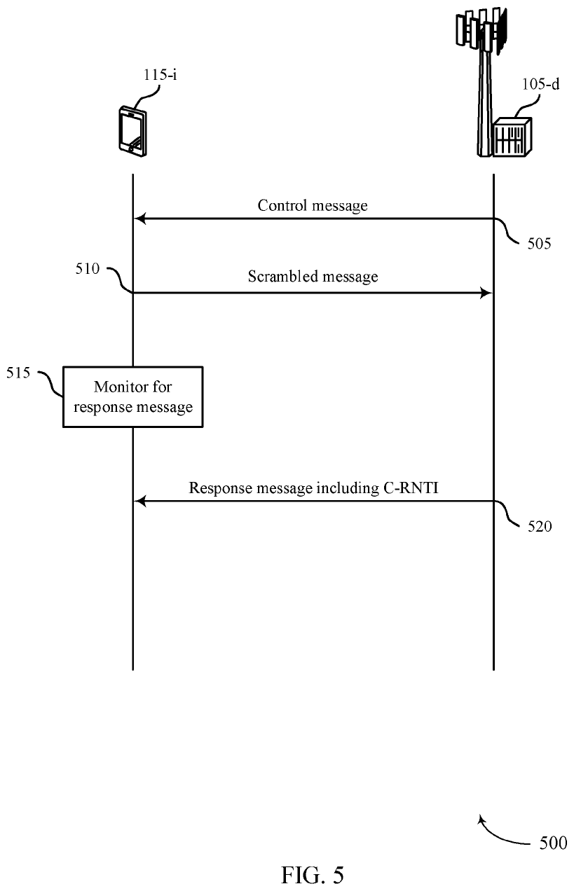

FIG. 5 illustrates an example of a process flow 500 that supports data transmission over uplink transmission resources shared by a large number of UEs in accordance with aspects of the present disclosure. The process flow 500 may implement aspects of wireless communications systems 100 and 200, or may be implemented by aspects of the wireless communications system 100 and 200. For example, the process flow 500 may illustrate operations between a UE 115-i and a base station 105-d, which may be examples of corresponding devices described herein. In the following description of the process flow 500, the operations between the UE 115-i and the base station 105-d may be transmitted in a different order than the example order shown, or the operations performed by the UE 115-i and the base station 105-d may be performed in different orders or at different times. Some operations may also be omitted from the process flow 500, and other operations may be added to the process flow 500.

At 505, the UE 115-i may receive, from the base station 105-d, a control message indicating a group identifier (e.g., a group-RNTI) assigned to a group of UEs that includes the UE 115-i, and indicating multiple uplink transmission resources allocated to the group of UEs. In some cases, the control message may indicate a search space including multiple control channel candidates.

At 510, the UE 115-i may transmit, to the base station 105-d and during a first uplink transmission resource of the multiple uplink transmission resources, a first message scrambled by the group identifier, where the first message includes a user equipment identifier of the UE 115-i (e.g., a C-RNTI). If the UE 115-i is in a connected state or an inactive state (e.g., RRC connected, RRC inactive), the UE 115-i may transmit the user equipment identifier in a MAC-CE. If the UE 115-i is in an idle state (e.g., RRC idle), the UE 115-i may transmit the user equipment identifier in a MAC-CE, where the user equipment identifier is derived based on a hash of a longer device identifier. At 515, the UE 115-i may monitor the search space for a first response message from the base station 105-d.

At 520, the UE 115-i may receive, from the base station 105-d and in response to transmitting the first message, a first response message scrambled by the user equipment identifier. The first response message may be transmitted in DCI. In some cases, the UE 115-i may receive the first response message based on monitoring the search space.

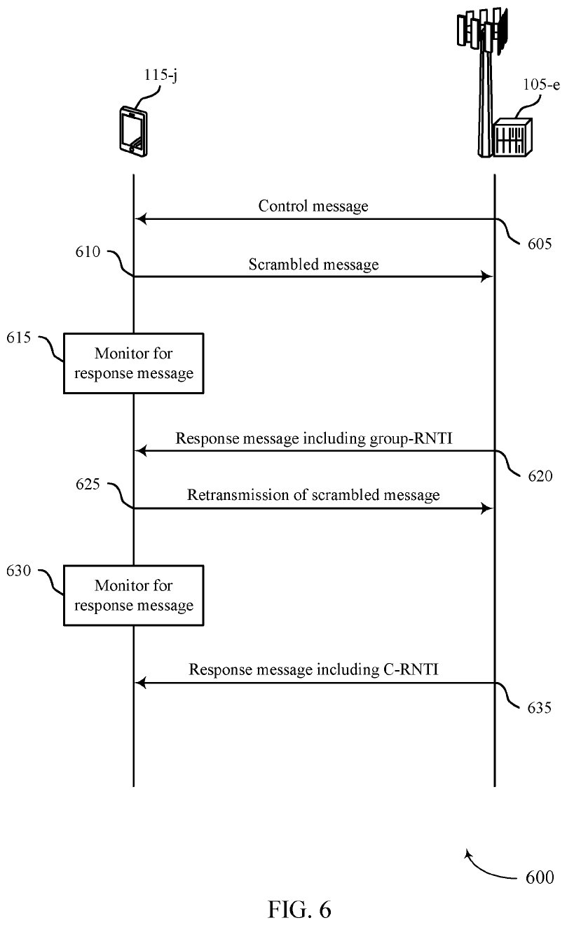

FIG. 6 illustrates an example of a process flow 600 that supports data transmission over uplink transmission resources shared by a large number of UEs in accordance with aspects of the present disclosure. The process flow 600 may implement aspects of wireless communications systems 100 and 200, or may be implemented by aspects of the wireless communications system 100 and 200. For example, the process flow 600 may illustrate operations between a UE 115-j and a base station 105-e, which may be examples of corresponding devices described herein. In the following description of the process flow 600, the operations between the UE 115-j and the base station 105-e may be transmitted in a different order than the example order shown, or the operations performed by the UE 115-j and the base station 105-e may be performed in different orders or at different times. Some operations may also be omitted from the process flow 600, and other operations may be added to the process flow 600.

At 605, the UE 115-j may receive, from the base station 105-e, a control message indicating a group identifier (e.g., a group-RNTI) assigned to a group of UEs that includes the UE 115-j, and indicating multiple uplink transmission resources allocated to the group of UEs. In some cases, the control message may indicate a search space including multiple control channel candidates.

At 610, the UE 115-j may transmit, to the base station 105-e and during a first uplink transmission resource of the multiple uplink transmission resources, a first message scrambled by the group identifier, where the first message includes a user equipment identifier of the UE 115-j (e.g., a C-RNTI). If the UE 115-j is in a connected state or an inactive state (e.g., RRC connected, RRC inactive), the UE 115-j may transmit the user equipment identifier in a MAC control element (MAC-CE). If the UE 115-j is in an idle state (e.g., RRC idle), the UE 115-j may transmit the user equipment identifier in a MAC-CE, where the user equipment identifier is derived based on a hash of a longer device identifier. At 615, the UE 115-j may monitor the search space for a first response message from the base station 105-e.

At 620, the UE 115-j may receive, from the base station 105-e and in response to transmitting the first message, a first response message scrambled by the group identifier. The first response message may be transmitted via a shared channel (e.g., PDSCH), and may include the group identifier, a set of uplink grants, a backoff indication, or any combination thereof.

At 625, the UE 115-j may transmit, to the base station 105-e, a second message that is a retransmission of the first message, the second message scrambled by the group identifier and including the user equipment identifier of the UE 115-j. In some cases, if the first response message includes the group identifier and a set of uplink grants, the UE 115-j may transmit the second message during a first resource allocated by a first grant of the set of uplink grants selected based on the user equipment identifier and a quantity of the set of uplink grants (e.g., based on hashing), or the UE 115-j may transmit the second message during a first resource allocated by a randomly selected grant of the set of uplink grants.

Additionally, or alternatively, if the first response message includes the group identifier and a backoff indication that indicates a first set of one or more uplink transmission resources of the set of uplink transmission resources to refrain from transmitting (e.g., to skip), the UE 115-j may transmit the second message during a second uplink transmission resource of the set of uplink transmission resources in accordance with the backoff indication. If the backoff indication includes a codepoint to a table of backoff intervals, the UE 115-j may transmit the second message during a second uplink transmission resource of the set of uplink transmission resources corresponding to a backoff interval from the table associated with the codepoint. In some examples, if the first response message includes the group identified, a set of uplink grants, and a backoff indication, the UE 115-j may transmit the second message during a resource allocated by a first uplink grant or in accordance with the backoff indication indicating to refrain from transmitting in at least one uplink transmission resource.

At 630, the UE 115-j may monitor the search space for a second response message from the base station 105-e. At 635, the UE 115-j may receive, from the base station 105-e and via DCI, the second response message in response to transmitting the second message, the second response message including one of the group identifier or the user equipment identifier.

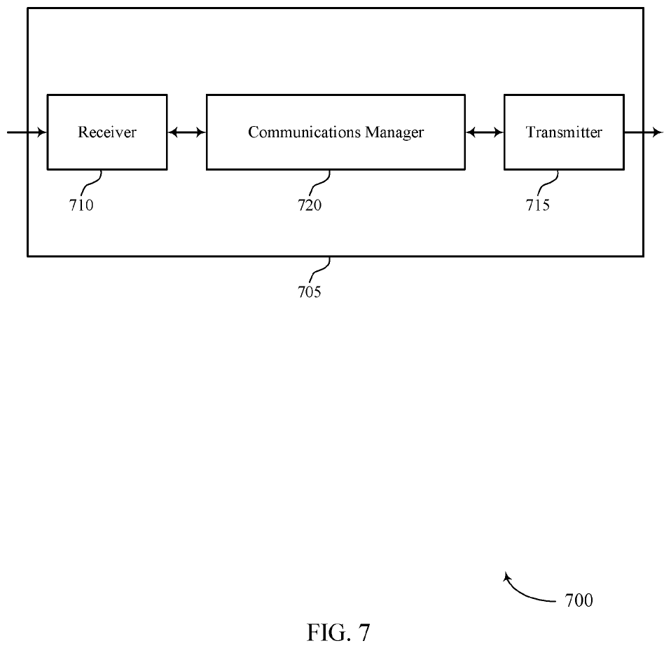

FIG. 7 shows a block diagram 700 of a device 705 that supports data transmission over uplink transmission resources shared by a large number of UEs in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to data transmission over uplink transmission resources shared by a large number of UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to data transmission over uplink transmission resources shared by a large number of UEs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of data transmission over uplink transmission resources shared by a large number of UEs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. For example, the communications manager 720 may be configured as or otherwise support a means for receiving a control message indicating a group identifier assigned to a group of UEs that includes the first UE and indicating a set of multiple uplink transmission resources allocated to the group of UEs. The communications manager 720 may be configured as or otherwise support a means for transmitting, during a first uplink transmission resource of the set of multiple uplink transmission resources, a first message scrambled by the group identifier, where the first message includes a user equipment identifier of the first UE. The communications manager 720 may be configured as or otherwise support a means for receiving a first response message including one of the group identifier or the user equipment identifier in response to transmitting the first message.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for data transmission over uplink transmission resources shared by a large number of UEs, which may reduce signaling overhead and limit processing.

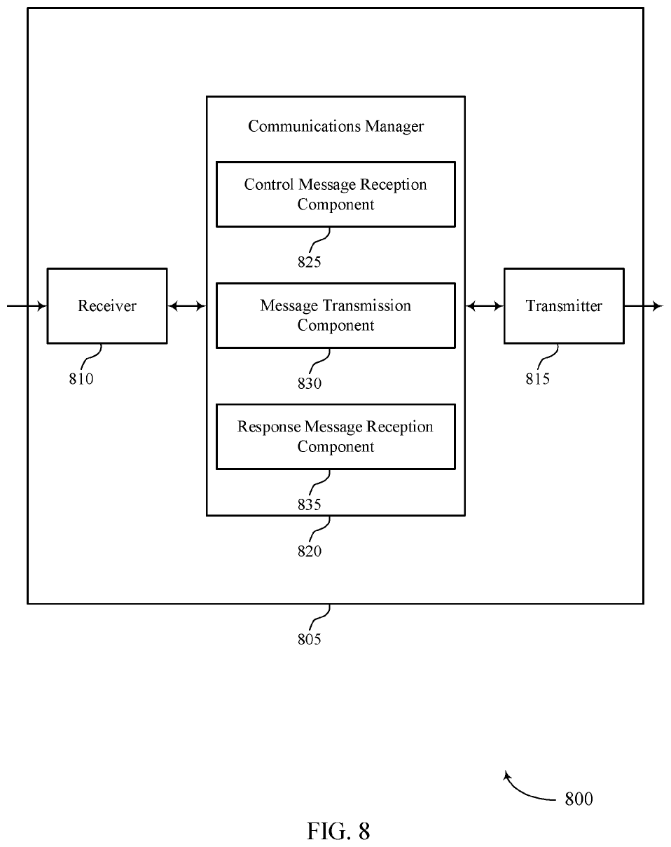

FIG. 8 shows a block diagram 800 of a device 805 that supports data transmission over uplink transmission resources shared by a large number of UEs in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to data transmission over uplink transmission resources shared by a large number of UEs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to data transmission over uplink transmission resources shared by a large number of UEs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of data transmission over uplink transmission resources shared by a large number of UEs as described herein. For example, the communications manager 820 may include a control message reception component 825, a message transmission component 830, a response message reception component 835, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. The control message reception component 825 may be configured as or otherwise support a means for receiving a control message indicating a group identifier assigned to a group of UEs that includes the first UE and indicating a set of multiple uplink transmission resources allocated to the group of UEs. The message transmission component 830 may be configured as or otherwise support a means for transmitting, during a first uplink transmission resource of the set of multiple uplink transmission resources, a first message scrambled by the group identifier, where the first message includes a user equipment identifier of the first UE. The response message reception component 835 may be configured as or otherwise support a means for receiving a first response message including one of the group identifier or the user equipment identifier in response to transmitting the first message.

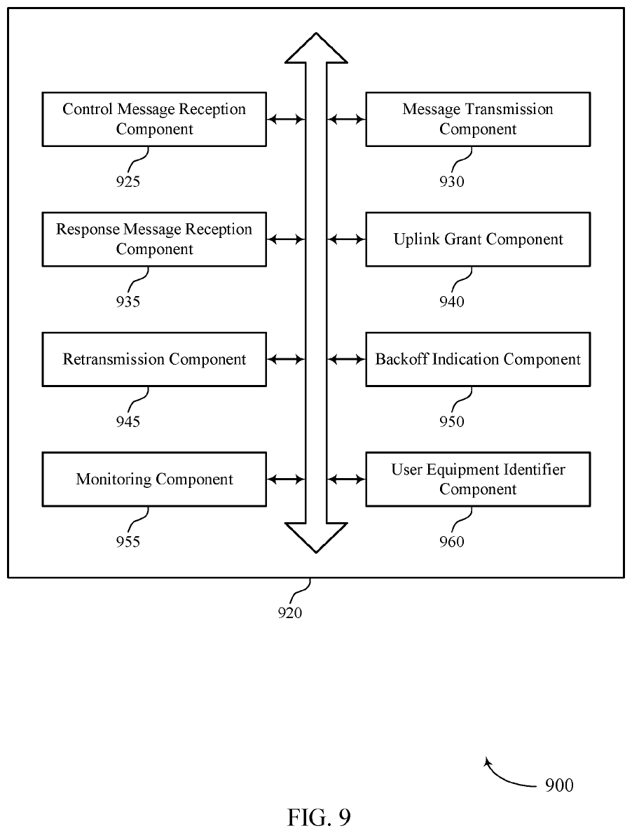

FIG. 9 shows a block diagram 900 of a communications manager 920 that supports data transmission over uplink transmission resources shared by a large number of UEs in accordance with aspects of the present disclosure. The communications manager 920 may be an example of aspects of a communications manager 720, a communications manager 820, or both, as described herein. The communications manager 920, or various components thereof, may be an example of means for performing various aspects of data transmission over uplink transmission resources shared by a large number of UEs as described herein. For example, the communications manager 920 may include a control message reception component 925, a message transmission component 930, a response message reception component 935, an uplink grant component 940, a retransmission component 945, a backoff indication component 950, a monitoring component 955, a user equipment identifier component 960, or any combination thereof. Each of these components may communicate, directly or indirectly, with one another (e.g., via one or more buses).

The communications manager 920 may support wireless communication at a first UE in accordance with examples as disclosed herein. The control message reception component 925 may be configured as or otherwise support a means for receiving a control message indicating a group identifier assigned to a group of UEs that includes the first UE and indicating a set of multiple uplink transmission resources allocated to the group of UEs. The message transmission component 930 may be configured as or otherwise support a means for transmitting, during a first uplink transmission resource of the set of multiple uplink transmission resources, a first message scrambled by the group identifier, where the first message includes a user equipment identifier of the first UE. The response message reception component 935 may be configured as or otherwise support a means for receiving a first response message including one of the group identifier or the user equipment identifier in response to transmitting the first message.

In some examples, to support receiving the first response message, the response message reception component 935 may be configured as or otherwise support a means for receiving, via DCI, the first response message scrambled by the user equipment identifier in response to transmitting the first message.

In some examples, to support receiving the first response message, the response message reception component 935 may be configured as or otherwise support a means for receiving, via a shared channel, the first response message scrambled by the group identifier in response to transmitting the first message.

In some examples, the retransmission component 945 may be configured as or otherwise support a means for transmitting a second message that is a retransmission of the first message based on receiving the first response message via the shared channel, the second message being scrambled by the group identifier and including the user equipment identifier of the first UE. In some examples, the response message reception component 935 may be configured as or otherwise support a means for receiving, via DCI, a second response message in response to transmitting the second message.

In some examples, to support receiving the first response message, the response message reception component 935 may be configured as or otherwise support a means for receiving, via a shared channel, the first response message including the group identifier, a set of multiple uplink grants, a backoff indication, or any combination thereof.

In some examples, to support receiving the first response message, the uplink grant component 940 may be configured as or otherwise support a means for receiving, via a shared channel, the first response message including the group identifier and a set of multiple uplink grants. In some examples, to support receiving the first response message, the retransmission component 945 may be configured as or otherwise support a means for transmitting, during a first resource allocated by a first grant of the set of multiple uplink grants selected based on the user equipment identifier and a quantity of the set of multiple uplink grants, a second message that is a retransmission of the first message, the second message scrambled by the group identifier and including the user equipment identifier of the first UE.

In some examples, to support receiving the first response message, the uplink grant component 940 may be configured as or otherwise support a means for receiving, via a shared channel, the first response message including the group identifier and a set of multiple uplink grants. In some examples, to support receiving the first response message, the retransmission component 945 may be configured as or otherwise support a means for transmitting, during a first resource allocated by a randomly selected grant of the set of multiple uplink grants, a second message that is a retransmission of the first message, the second message scrambled by the group identifier and including the user equipment identifier of the first UE.

In some examples, to support receiving the first response message, the response message reception component 935 may be configured as or otherwise support a means for receiving, via a shared channel, the first response message including the group identifier. In some examples, to support receiving the first response message, the retransmission component 945 may be configured as or otherwise support a means for transmitting, during a second uplink transmission resource of the set of multiple uplink transmission resources, a second message that is a retransmission of the first message, the second message scrambled by the group identifier and including the user equipment identifier of the first UE.

In some examples, to support receiving the first response message, the backoff indication component 950 may be configured as or otherwise support a means for receiving, via a shared channel, the first response message including the group identifier and a backoff indication, where the backoff indication indicates a first set of one or more uplink transmission resources of the set of multiple uplink transmission resources to refrain from transmitting. In some examples, to support receiving the first response message, the retransmission component 945 may be configured as or otherwise support a means for transmitting, during a second uplink transmission resource of the set of multiple uplink transmission resources in accordance with the backoff indication, a second message that is a retransmission of the first message, the second message scrambled by the group identifier and including the user equipment identifier of the first UE.

In some examples, to support receiving the first response message, the backoff indication component 950 may be configured as or otherwise support a means for receiving, via a shared channel, the first response message including the group identifier and a backoff indication, where the backoff indication includes a codepoint to a table of backoff intervals. In some examples, to support receiving the first response message, the retransmission component 945 may be configured as or otherwise support a means for transmitting, during a second uplink transmission resource of the set of multiple uplink transmission resources corresponding to a backoff interval from the table associated with the codepoint, a second message that is a retransmission of the first message, the second message scrambled by the group identifier and including the user equipment identifier of the first UE.

In some examples, to support receiving the first response message, the response message reception component 935 may be configured as or otherwise support a means for receiving, via a shared channel, the first response message including the group identifier, a set of multiple uplink grants, and a backoff indication. In some examples, to support receiving the first response message, the retransmission component 945 may be configured as or otherwise support a means for transmitting, during a resource allocated by a first uplink grant or in accordance with the backoff indication indicating to refrain from transmitting in at least one uplink transmission resource of the set of multiple uplink transmission resources, a second message that is a retransmission of the first message, the second message scrambled by the group identifier and including the user equipment identifier of the first UE.

In some examples, the control message reception component 925 may be configured as or otherwise support a means for receiving the control message indicating a search space including a set of multiple control channel candidates. In some examples, the monitoring component 955 may be configured as or otherwise support a means for monitoring the search space for the first response message. In some examples, the response message reception component 935 may be configured as or otherwise support a means for receiving the first response message in a first control channel candidate of the set of multiple control channel candidates based on the monitoring.

In some examples, to support transmitting the first message, the user equipment identifier component 960 may be configured as or otherwise support a means for transmitting, in a MAC-CE, the user equipment identifier, where the first UE is in a connected state or an inactive state.

In some examples, to support transmitting the first message, the user equipment identifier component 960 may be configured as or otherwise support a means for transmitting, in a MAC-CE, the first message, where the user equipment identifier of the first UE is derived based on a hash of a longer device identifier, and where the first UE is in an idle state. In some examples, the group identifier corresponds to a group-RNTI and the user equipment identifier corresponds to a C-RNTI.

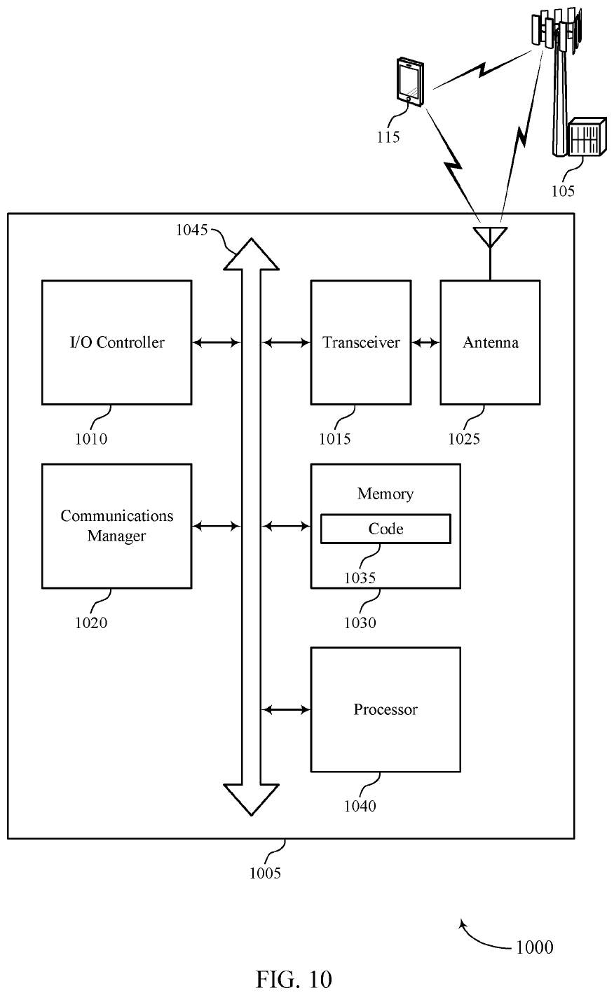

FIG. 10 shows a diagram of a system 1000 including a device 1005 that supports data transmission over uplink transmission resources shared by a large number of UEs in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting data transmission over uplink transmission resources shared by a large number of UEs). For example, the device 1005 or a component of the device 1005 may include a processor 1040 and memory 1030 coupled with the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for receiving a control message indicating a group identifier assigned to a group of UEs that includes the first UE and indicating a set of multiple uplink transmission resources allocated to the group of UEs. The communications manager 1020 may be configured as or otherwise support a means for transmitting, during a first uplink transmission resource of the set of multiple uplink transmission resources, a first message scrambled by the group identifier, where the first message includes a user equipment identifier of the first UE. The communications manager 1020 may be configured as or otherwise support a means for receiving a first response message including one of the group identifier or the user equipment identifier in response to transmitting the first message.

By including or configuring the communications manager 1020 in accordance with examples as described herein, the device 1005 may support techniques for data transmission over uplink transmission resources shared by a large number of UEs, which may reduce signaling overhead and limit processing.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of data transmission over uplink transmission resources shared by a large number of UEs as described herein, or the processor 1040 and the memory 1030 may be otherwise configured to perform or support such operations.

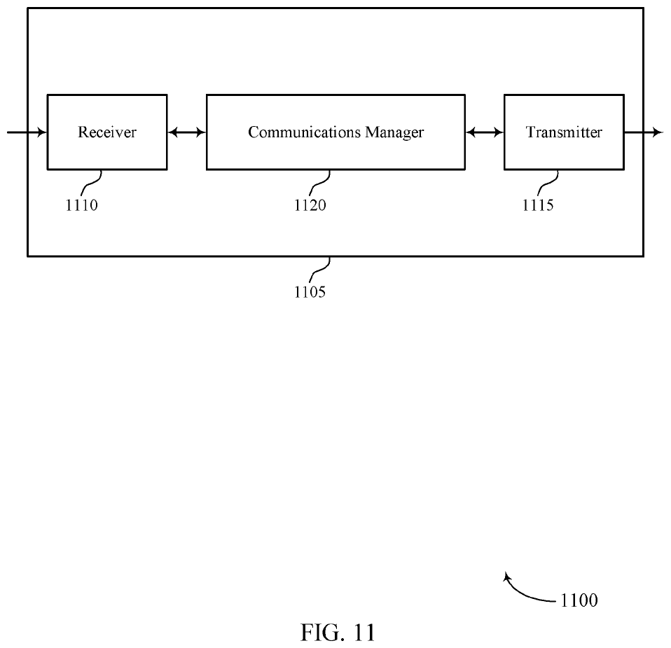

FIG. 11 shows a block diagram 1100 of a device 1105 that supports data transmission over uplink transmission resources shared by a large number of UEs in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to data transmission over uplink transmission resources shared by a large number of UEs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to data transmission over uplink transmission resources shared by a large number of UEs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of data transmission over uplink transmission resources shared by a large number of UEs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a base station in accordance with examples as disclosed herein. For example, the communications manager 1120 may be configured as or otherwise support a means for transmitting a control message indicating a group identifier assigned to a group of UEs that includes a first UE and indicating a set of multiple uplink transmission resources allocated to the group of UEs. The communications manager 1120 may be configured as or otherwise support a means for receiving, from the first UE and during a first uplink transmission resource of the set of multiple uplink transmission resources, a first message scrambled by the group identifier. The communications manager 1120 may be configured as or otherwise support a means for transmitting, to the first UE, a first response message including one of the group identifier or a user equipment identifier indicated in the first message in response to transmitting the first message.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for data transmission over uplink transmission resources shared by a large number of UEs, which may reduce signaling overhead and limit processing.

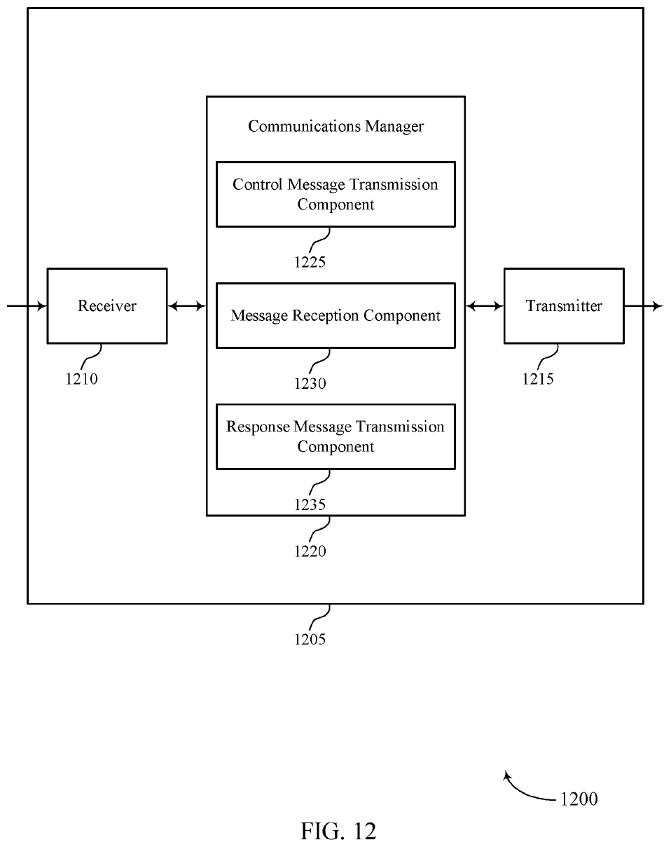

FIG. 12 shows a block diagram 1200 of a device 1205 that supports data transmission over uplink transmission resources shared by a large number of UEs in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to data transmission over uplink transmission resources shared by a large number of UEs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to data transmission over uplink transmission resources shared by a large number of UEs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of data transmission over uplink transmission resources shared by a large number of UEs as described herein. For example, the communications manager 1220 may include a control message transmission component 1225, a message reception component 1230, a response message transmission component 1235, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a base station in accordance with examples as disclosed herein. The control message transmission component 1225 may be configured as or otherwise support a means for transmitting a control message indicating a group identifier assigned to a group of UEs that includes a first UE and indicating a set of multiple uplink transmission resources allocated to the group of UEs. The message reception component 1230 may be configured as or otherwise support a means for receiving, from the first UE and during a first uplink transmission resource of the set of multiple uplink transmission resources, a first message scrambled by the group identifier. The response message transmission component 1235 may be configured as or otherwise support a means for transmitting, to the first UE, a first response message including one of the group identifier or a user equipment identifier indicated in the first message in response to transmitting the first message.

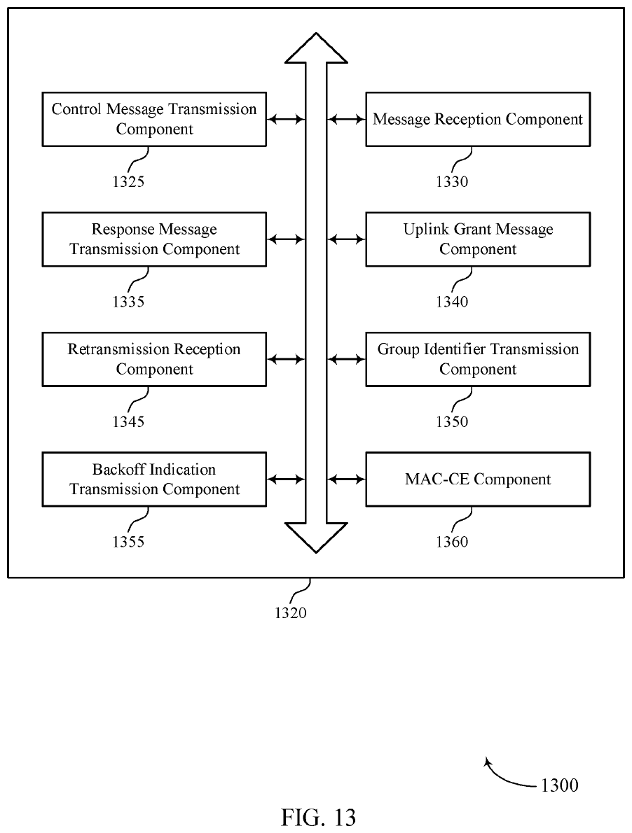

FIG. 13 shows a block diagram 1300 of a communications manager 1320 that supports data transmission over uplink transmission resources shared by a large number of UEs in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of data transmission over uplink transmission resources shared by a large number of UEs as described herein. For example, the communications manager 1320 may include a control message transmission component 1325, a message reception component 1330, a response message transmission component 1335, an uplink grant message component 1340, a retransmission reception component 1345, a group identifier transmission component 1350, a backoff indication transmission component 1355, a MAC-CE component 1360, or any combination thereof. Each of these components may communicate, directly or indirectly, with one another (e.g., via one or more buses).

The communications manager 1320 may support wireless communication at a base station in accordance with examples as disclosed herein. The control message transmission component 1325 may be configured as or otherwise support a means for transmitting a control message indicating a group identifier assigned to a group of UEs that includes a first UE and indicating a set of multiple uplink transmission resources allocated to the group of UEs. The message reception component 1330 may be configured as or otherwise support a means for receiving, from the first UE and during a first uplink transmission resource of the set of multiple uplink transmission resources, a first message scrambled by the group identifier. The response message transmission component 1335 may be configured as or otherwise support a means for transmitting, to the first UE, a first response message including one of the group identifier or a user equipment identifier indicated in the first message in response to transmitting the first message.

In some examples, to support transmitting the first response message, the response message transmission component 1335 may be configured as or otherwise support a means for transmitting, via DCI, the first response message scrambled by the user equipment identifier in response to receiving the first message.

In some examples, to support transmitting the first response message, the response message transmission component 1335 may be configured as or otherwise support a means for transmitting, via a shared channel, the first response message scrambled by the group identifier in response to receiving the first message.

In some examples, the message reception component 1330 may be configured as or otherwise support a means for receiving a second message that is a retransmission of the first message based on transmitting the first response message via the shared channel, the second message being scrambled by the group identifier and including the user equipment identifier of the first UE. In some examples, the response message transmission component 1335 may be configured as or otherwise support a means for transmitting, via DCI, a second response message in response to receiving the second message.

In some examples, to support transmitting the first response message, the response message transmission component 1335 may be configured as or otherwise support a means for transmitting, via a shared channel, the first response message including the group identifier, a set of multiple uplink grants, a backoff indication or any combination thereof.

In some examples, to support transmitting the first response message, the uplink grant message component 1340 may be configured as or otherwise support a means for transmitting, via a shared channel, the first response message including the group identifier and a set of multiple uplink grants. In some examples, to support transmitting the first response message, the retransmission reception component 1345 may be configured as or otherwise support a means for receiving, during a first resource allocated by a first grant of the set of multiple uplink grants selected based on the user equipment identifier and a quantity of the set of multiple uplink grants, a second message that is a retransmission of the first message, the second message scrambled by the group identifier and including the user equipment identifier of the first UE.

In some examples, to support transmitting the first response message, the uplink grant message component 1340 may be configured as or otherwise support a means for transmitting, via a shared channel, the first response message including the group identifier and a set of multiple uplink grants. In some examples, to support transmitting the first response message, the retransmission reception component 1345 may be configured as or otherwise support a means for receiving, during a first resource allocated by a randomly selected grant of the set of multiple uplink grants, a second message that is a retransmission of the first message, the second message scrambled by the group identifier and including the user equipment identifier of the first UE.

In some examples, to support transmitting the first response message, the group identifier transmission component 1350 may be configured as or otherwise support a means for transmitting, via a shared channel, the first response message including the group identifier. In some examples, to support transmitting the first response message, the retransmission reception component 1345 may be configured as or otherwise support a means for receiving, during a second uplink transmission resource of the set of multiple uplink transmission resources, a second message that is a retransmission of the first message, the second message scrambled by the group identifier and including the user equipment identifier of the first UE.

In some examples, to support transmitting the first response message, the backoff indication transmission component 1355 may be configured as or otherwise support a means for transmitting, via a shared channel, the first response message including the group identifier and a backoff indication, where the backoff indication indicates a first set of one or uplink transmission resources of the set of multiple uplink transmission resources to refrain from transmitting. In some examples, to support transmitting the first response message, the retransmission reception component 1345 may be configured as or otherwise support a means for receiving, during a second uplink transmission resource of the set of multiple uplink transmission resources in accordance with the backoff indication, a second message that is a retransmission of the first message, the second message scrambled by the group identifier and including the user equipment identifier of the first UE.

In some examples, to support transmitting the first response message, the backoff indication transmission component 1355 may be configured as or otherwise support a means for transmitting, via a shared channel, the first response message including the group identifier and a backoff indication, where the backoff indication includes a codepoint to a table of backoff intervals. In some examples, to support transmitting the first response message, the retransmission reception component 1345 may be configured as or otherwise support a means for receiving, during a second uplink transmission resource of the set of multiple uplink transmission resources corresponding to a backoff interval from the table associated with the codepoint, a second message that is a retransmission of the first message, the second message scrambled by the group identifier and including the user equipment identifier of the first UE.

In some examples, to support receiving the first response message, the response message transmission component 1335 may be configured as or otherwise support a means for receiving, via a shared channel, the first response message including the group identifier, a set of multiple uplink grants, and a backoff indication. In some examples, to support receiving the first response message, the retransmission reception component 1345 may be configured as or otherwise support a means for transmitting, during a resource allocated by a first uplink grant or in accordance with the backoff indication indicating to refrain from transmitting in at least one uplink transmission resource of the set of multiple uplink transmission resources, a second message that is a retransmission of the first message, the second message scrambled by the group identifier and including the user equipment identifier of the first UE.

In some examples, the control message transmission component 1325 may be configured as or otherwise support a means for transmitting the control message indicating a search space including a set of multiple control channel candidates. In some examples, the response message transmission component 1335 may be configured as or otherwise support a means for transmitting the first response message in a first control channel candidate of the set of multiple control channel candidates based on transmitting the control message.

In some examples, to support receiving the first message, the MAC-CE component 1360 may be configured as or otherwise support a means for receiving, in a MAC-CE, the user equipment identifier, where the first UE is in a connected state or an inactive state.

In some examples, to support receiving the first message, the MAC-CE component 1360 may be configured as or otherwise support a means for receiving, in a MAC-CE, the first message, where the user equipment identifier of the first UE is derived based on a hash of a longer device identifier, and where the first UE is in an idle state. In some examples, the group identifier corresponds to a group-RNTI and the user equipment identifier corresponds to a C-RNTI.

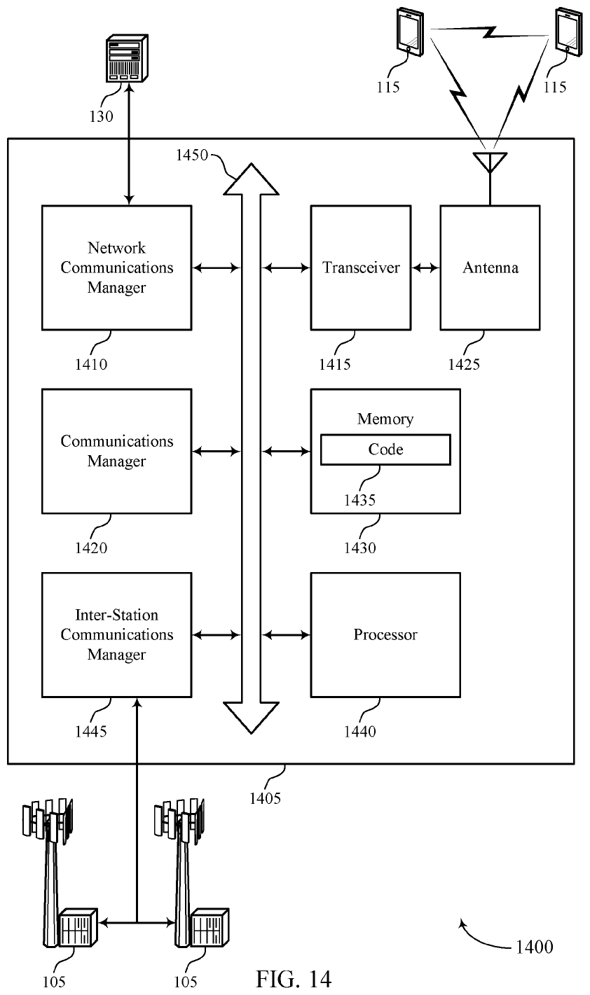

FIG. 14 shows a diagram of a system 1400 including a device 1405 that supports data transmission over uplink transmission resources shared by a large number of UEs in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting data transmission over uplink transmission resources shared by a large number of UEs). For example, the device 1405 or a component of the device 1405 may include a processor 1440 and memory 1430 coupled with the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a base station in accordance with examples as disclosed herein. For example, the communications manager 1420 may be configured as or otherwise support a means for transmitting a control message indicating a group identifier assigned to a group of UEs includes a first UE and indicating a set of multiple uplink transmission resources allocated to the group of UEs. The communications manager 1420 may be configured as or otherwise support a means for receiving, from the first UE and during a first uplink transmission resource of the set of multiple uplink transmission resources, a first message scrambled by the group identifier. The communications manager 1420 may be configured as or otherwise support a means for transmitting, to the first UE, a first response message including one of the group identifier or a user equipment identifier indicated in the first message in response to transmitting the first message.

By including or configuring the communications manager 1420 in accordance with examples as described herein, the device 1405 may support techniques for data transmission over uplink transmission resources shared by a large number of UEs, which may reduce signaling overhead and limit processing.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of data transmission over uplink transmission resources shared by a large number of UEs as described herein, or the processor 1440 and the memory 1430 may be otherwise configured to perform or support such operations.

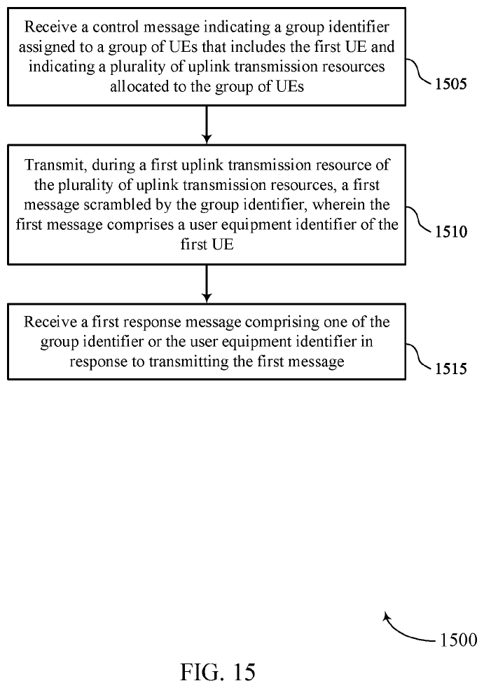

FIG. 15 shows a flowchart illustrating a method 1500 that supports data transmission over uplink transmission resources shared by a large number of UEs in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving a control message indicating a group identifier assigned to a group of UEs that includes the first UE and indicating a set of multiple uplink transmission resources allocated to the group of UEs. The operations of 1505 may be performed in accordance with examples as disclosed herein. In some examples, aspects of the operations of 1505 may be performed by a control message reception component 925 as described with reference to FIG. 9.

At 1510, the method may include transmitting, during a first uplink transmission resource of the set of multiple uplink transmission resources, a first message scrambled by the group identifier, where the first message includes a user equipment identifier of the first UE. The operations of 1510 may be performed in accordance with examples as disclosed herein. In some examples, aspects of the operations of 1510 may be performed by a message transmission component 930 as described with reference to FIG. 9.

At 1515, the method may include receiving a first response message including one of the group identifier or the user equipment identifier in response to transmitting the first message. The operations of 1515 may be performed in accordance with examples as disclosed herein. In some examples, aspects of the operations of 1515 may be performed by a response message reception component 935 as described with reference to FIG. 9.

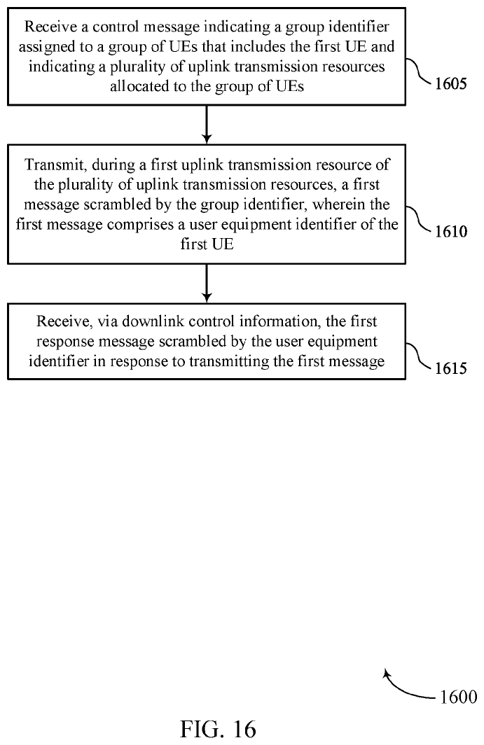

FIG. 16 shows a flowchart illustrating a method 1600 that supports data transmission over uplink transmission resources shared by a large number of UEs in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving a control message indicating a group identifier assigned to a group of UEs that includes the first UE and indicating a set of multiple uplink transmission resources allocated to the group of UEs. The operations of 1605 may be performed in accordance with examples as disclosed herein. In some examples, aspects of the operations of 1605 may be performed by a control message reception component 925 as described with reference to FIG. 9.

At 1610, the method may include transmitting, during a first uplink transmission resource of the set of multiple uplink transmission resources, a first message scrambled by the group identifier, where the first message includes a user equipment identifier of the first UE. The operations of 1610 may be performed in accordance with examples as disclosed herein. In some examples, aspects of the operations of 1610 may be performed by a message transmission component 930 as described with reference to FIG. 9.

At 1615, the method may include receiving, via DCI, the first response message scrambled by the user equipment identifier in response to transmitting the first message. The operations of 1615 may be performed in accordance with examples as disclosed herein. In some examples, aspects of the operations of 1615 may be performed by a response message reception component 935 as described with reference to FIG. 9.

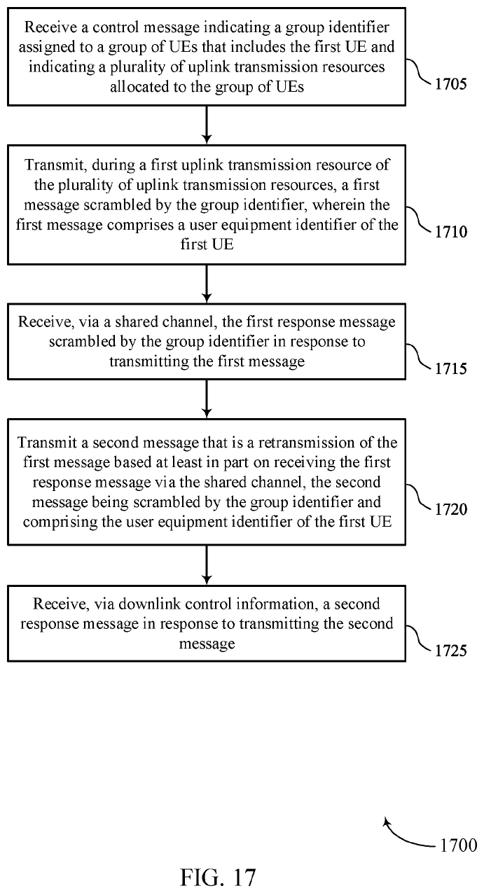

FIG. 17 shows a flowchart illustrating a method 1700 that supports data transmission over uplink transmission resources shared by a large number of UEs in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1705, the method may include receiving a control message indicating a group identifier assigned to a group of UEs that includes the first UE and indicating a set of multiple uplink transmission resources allocated to the group of UEs. The operations of 1705 may be performed in accordance with examples as disclosed herein. In some examples, aspects of the operations of 1705 may be performed by a control message reception component 925 as described with reference to FIG. 9.

At 1710, the method may include transmitting, during a first uplink transmission resource of the set of multiple uplink transmission resources, a first message scrambled by the group identifier, where the first message includes a user equipment identifier of the first UE. The operations of 1710 may be performed in accordance with examples as disclosed herein. In some examples, aspects of the operations of 1710 may be performed by a message transmission component 930 as described with reference to FIG. 9.

At 1715, the method may include receiving, via a shared channel, the first response message scrambled by the group identifier in response to transmitting the first message. The operations of 1715 may be performed in accordance with examples as disclosed herein. In some examples, aspects of the operations of 1715 may be performed by a response message reception component 935 as described with reference to FIG. 9.

At 1720, the method may include transmitting a second message that is a retransmission of the first message based on receiving the first response message via the shared channel, the second message being scrambled by the group identifier and including the user equipment identifier of the first UE. The operations of 1720 may be performed in accordance with examples as disclosed herein. In some examples, aspects of the operations of 1720 may be performed by a retransmission component 945 as described with reference to FIG. 9.

At 1725, the method may include receiving, via DCI, a second response message in response to transmitting the second message. The operations of 1725 may be performed in accordance with examples as disclosed herein. In some examples, aspects of the operations of 1725 may be performed by a response message reception component 935 as described with reference to FIG. 9.

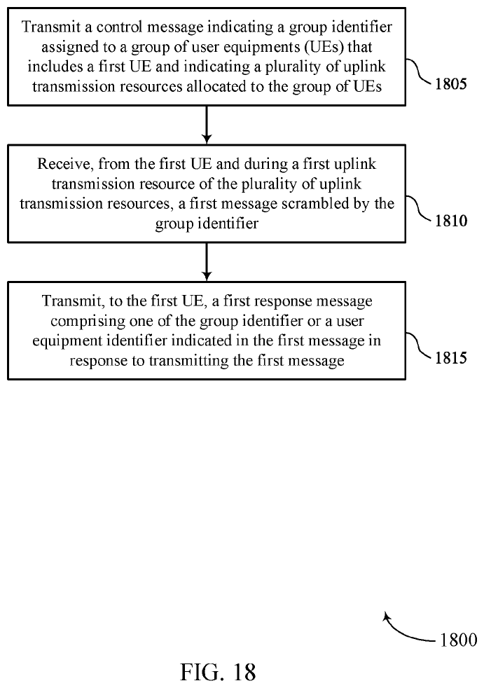

FIG. 18 shows a flowchart illustrating a method 1800 that supports data transmission over uplink transmission resources shared by a large number of UEs in accordance with aspects of the present disclosure. The operations of the method 1800 may be implemented by a base station or its components as described herein. For example, the operations of the method 1800 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1805, the method may include transmitting a control message indicating a group identifier assigned to a group of UEs that includes a first UE and indicating a set of multiple uplink transmission resources allocated to the group of UEs. The operations of 1805 may be performed in accordance with examples as disclosed herein. In some examples, aspects of the operations of 1805 may be performed by a control message transmission component 1325 as described with reference to FIG. 13.

At 1810, the method may include receiving, from the first UE and during a first uplink transmission resource of the set of multiple uplink transmission resources, a first message scrambled by the group identifier. The operations of 1810 may be performed in accordance with examples as disclosed herein. In some examples, aspects of the operations of 1810 may be performed by a message reception component 1330 as described with reference to FIG. 13.

At 1815, the method may include transmitting, to the first UE, a first response message including one of the group identifier or a user equipment identifier indicated in the first message in response to transmitting the first message. The operations of 1815 may be performed in accordance with examples as disclosed herein. In some examples, aspects of the operations of 1815 may be performed by a response message transmission component 1335 as described with reference to FIG. 13.

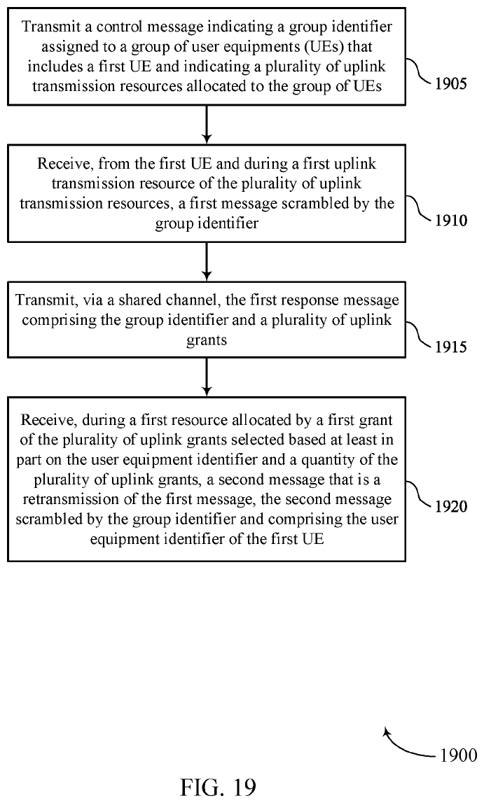

FIG. 19 shows a flowchart illustrating a method 1900 that supports data transmission over uplink transmission resources shared by a large number of UEs in accordance with aspects of the present disclosure. The operations of the method 1900 may be implemented by a base station or its components as described herein. For example, the operations of the method 1900 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1905, the method may include transmitting a control message indicating a group identifier assigned to a group of UEs that includes a first UE and indicating a set of multiple uplink transmission resources allocated to the group of UEs. The operations of 1905 may be performed in accordance with examples as disclosed herein. In some examples, aspects of the operations of 1905 may be performed by a control message transmission component 1325 as described with reference to FIG. 13.

At 1910, the method may include receiving, from the first UE and during a first uplink transmission resource of the set of multiple uplink transmission resources, a first message scrambled by the group identifier. The operations of 1910 may be performed in accordance with examples as disclosed herein. In some examples, aspects of the operations of 1910 may be performed by a message reception component 1330 as described with reference to FIG. 13.

At 1915, the method may include transmitting, via a shared channel, the first response message including the group identifier and a set of multiple uplink grants. The operations of 1915 may be performed in accordance with examples as disclosed herein. In some examples, aspects of the operations of 1915 may be performed by an uplink grant message component 1340 as described with reference to FIG. 13.

At 1920, the method may include receiving, during a first resource allocated by a first grant of the set of multiple uplink grants selected based on the user equipment identifier and a quantity of the set of multiple uplink grants, a second message that is a retransmission of the first message, the second message scrambled by the group identifier and including the user equipment identifier of the first UE. The operations of 1920 may be performed in accordance with examples as disclosed herein. In some examples, aspects of the operations of 1920 may be performed by a retransmission reception component 1345 as described with reference to FIG. 13.

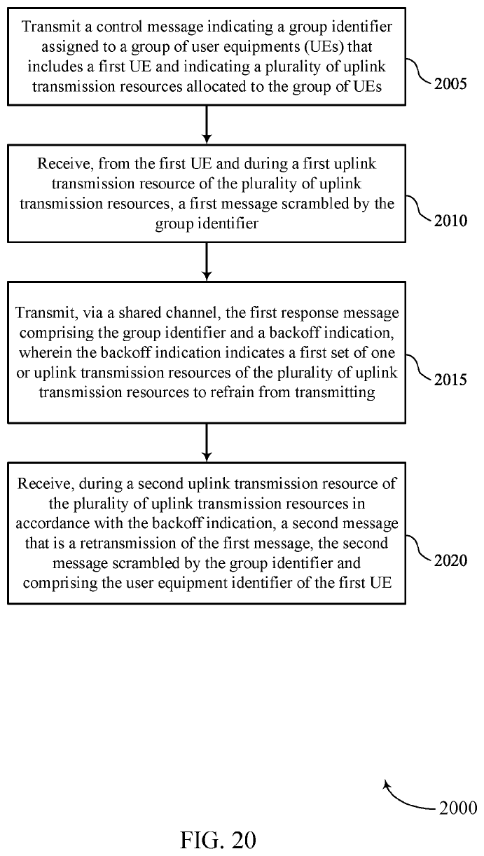

FIG. 20 shows a flowchart illustrating a method 2000 that supports data transmission over uplink transmission resources shared by a large number of UEs in accordance with aspects of the present disclosure. The operations of the method 2000 may be implemented by a base station or its components as described herein. For example, the operations of the method 2000 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 2005, the method may include transmitting a control message indicating a group identifier assigned to a group of UEs that includes a first UE and indicating a set of multiple uplink transmission resources allocated to the group of UEs. The operations of 2005 may be performed in accordance with examples as disclosed herein. In some examples, aspects of the operations of 2005 may be performed by a control message transmission component 1325 as described with reference to FIG. 13.

At 2010, the method may include receiving, from the first UE and during a first uplink transmission resource of the set of multiple uplink transmission resources, a first message scrambled by the group identifier. The operations of 2010 may be performed in accordance with examples as disclosed herein. In some examples, aspects of the operations of 2010 may be performed by a message reception component 1330 as described with reference to FIG. 13.

At 2015, the method may include transmitting, via a shared channel, the first response message including the group identifier and a backoff indication, where the backoff indication indicates a first set of one or uplink transmission resources of the set of multiple uplink transmission resources to refrain from transmitting. The operations of 2015 may be performed in accordance with examples as disclosed herein. In some examples, aspects of the operations of 2015 may be performed by a backoff indication transmission component 1355 as described with reference to FIG. 13.

At 2020, the method may include receiving, during a second uplink transmission resource of the set of multiple uplink transmission resources in accordance with the backoff indication, a second message that is a retransmission of the first message, the second message scrambled by the group identifier and including the user equipment identifier of the first UE. The operations of 2020 may be performed in accordance with examples as disclosed herein. In some examples, aspects of the operations of 2020 may be performed by a retransmission reception component 1345 as described with reference to FIG. 13. The following provides an overview of aspects of the present disclosure:

Aspect 1: A method for wireless communication at a first UE, comprising: receiving a control message indicating a group identifier assigned to a group of UEs that includes the first UE and indicating a plurality of uplink transmission resources allocated to the group of UEs; transmitting, during a first uplink transmission resource of the plurality of uplink transmission resources, a first message scrambled by the group identifier, wherein the first message comprises a user equipment identifier of the first UE; and receiving a first response message comprising one of the group identifier or the user equipment identifier in response to transmitting the first message.

Aspect 2: The method of aspect 1, wherein receiving the first response message comprises: receiving, via DCI, the first response message scrambled by the user equipment identifier in response to transmitting the first message.

Aspect 3: The method of any of aspects 1 through 2, wherein receiving the first response message comprises: receiving, via a shared channel, the first response message scrambled by the group identifier in response to transmitting the first message.

Aspect 4: The method of aspect 3, further comprising: transmitting a second message that is a retransmission of the first message based at least in part on receiving the first response message via the shared channel, the second message being scrambled by the group identifier and comprising the user equipment identifier of the first UE; and receiving, via DCI, a second response message in response to transmitting the second message.

Aspect 5: The method of any of aspects 1 through 4, wherein receiving the first response message comprises: receiving, via a shared channel, the first response message comprising the group identifier, a plurality of uplink grants, a backoff indication, or any combination thereof.

Aspect 6: The method of any of aspects 1 through 5, wherein receiving the first response message comprises: receiving, via a shared channel, the first response message comprising the group identifier and a plurality of uplink grants; and transmitting, during a first resource allocated by a first grant of the plurality of uplink grants selected based at least in part on the user equipment identifier and a quantity of the plurality of uplink grants, a second message that is a retransmission of the first message, the second message scrambled by the group identifier and comprising the user equipment identifier of the first UE.

Aspect 7: The method of any of aspects 1 through 6, wherein receiving the first response message comprises: receiving, via a shared channel, the first response message comprising the group identifier and a plurality of uplink grants; and transmitting, during a first resource allocated by a randomly selected grant of the plurality of uplink grants, a second message that is a retransmission of the first message, the second message scrambled by the group identifier and comprising the user equipment identifier of the first UE.

Aspect 8: The method of any of aspects 1 through 7, wherein receiving the first response message comprises: receiving, via a shared channel, the first response message comprising the group identifier; and transmitting, during a second uplink transmission resource of the plurality of uplink transmission resources, a second message that is a retransmission of the first message, the second message scrambled by the group identifier and comprising the user equipment identifier of the first UE.

Aspect 9: The method of any of aspects 1 through 8, wherein receiving the first response message comprises: receiving, via a shared channel, the first response message comprising the group identifier and a backoff indication, wherein the backoff indication indicates a first set of one or more uplink transmission resources of the plurality of uplink transmission resources to refrain from transmitting; and transmitting, during a second uplink transmission resource of the plurality of uplink transmission resources in accordance with the backoff indication, a second message that is a retransmission of the first message, the second message scrambled by the group identifier and comprising the user equipment identifier of the first UE.

Aspect 10: The method of any of aspects 1 through 9, wherein receiving the first response message comprises: receiving, via a shared channel, the first response message comprising the group identifier and a backoff indication, wherein the backoff indication comprises a codepoint to a table of backoff intervals; and transmitting, during a second uplink transmission resource of the plurality of uplink transmission resources corresponding to a backoff interval from the table associated with the codepoint, a second message that is a retransmission of the first message, the second message scrambled by the group identifier and comprising the user equipment identifier of the first UE.

Aspect 11: The method of any of aspects 1 through 10, wherein receiving the first response message comprises: receiving, via a shared channel, the first response message comprising the group identifier, a plurality of uplink grants, and a backoff indication; and transmitting, during a resource allocated by a first uplink grant or in accordance with the backoff indication indicating to refrain from transmitting in at least one uplink transmission resource of the plurality of uplink transmission resources, a second message that is a retransmission of the first message, the second message scrambled by the group identifier and comprising the user equipment identifier of the first UE.

Aspect 12: The method of any of aspects 1 through 11, further comprising: receiving the control message indicating a search space comprising a plurality of control channel candidates; monitoring the search space for the first response message; and receiving the first response message in a first control channel candidate of the plurality of control channel candidates based at least in part on the monitoring.

Aspect 13: The method of any of aspects 1 through 12, wherein transmitting the first message comprises: transmitting, in a MAC-CE, the user equipment identifier, wherein the first UE is in a connected state or an inactive state.

Aspect 14: The method of any of aspects 1 through 13, wherein transmitting the first message comprises: transmitting, in a MAC-CE, the first message, wherein the user equipment identifier of the first UE is derived based at least in part on a hash of a longer device identifier, and wherein the first UE is in an idle state.

Aspect 15: The method of any of aspects 1 through 14, wherein the group identifier corresponds to a group-RNTI and the user equipment identifier corresponds to a C-RNTI.

Aspect 16: A method for wireless communication at a base station, comprising: transmitting a control message indicating a group identifier assigned to a group of UEs that includes a first UE and indicating a plurality of uplink transmission resources allocated to the group of UEs; receiving, from the first UE and during a first uplink transmission resource of the plurality of uplink transmission resources, a first message scrambled by the group identifier; and transmitting, to the first UE, a first response message comprising one of the group identifier or a user equipment identifier indicated in the first message in response to transmitting the first message.

Aspect 17: The method of aspect 16, wherein transmitting the first response message comprises: transmitting, via DCI, the first response message scrambled by the user equipment identifier in response to receiving the first message.

Aspect 18: The method of any of aspects 16 through 17, wherein transmitting the first response message comprises: transmitting, via a shared channel, the first response message scrambled by the group identifier in response to receiving the first message.

Aspect 19: The method of aspect 18, further comprising: receiving a second message that is a retransmission of the first message based at least in part on transmitting the first response message via the shared channel, the second message being scrambled by the group identifier and comprising the user equipment identifier of the first UE; and transmitting, via DCI, a second response message in response to receiving the second message.

Aspect 20: The method of any of aspects 16 through 19, wherein transmitting the first response message comprises: transmitting, via a shared channel, the first response message comprising the group identifier, a plurality of uplink grants, a backoff indication or any combination thereof.

Aspect 21: The method of any of aspects 16 through 20, wherein transmitting the first response message comprises: transmitting, via a shared channel, the first response message comprising the group identifier and a plurality of uplink grants; and receiving, during a first resource allocated by a first grant of the plurality of uplink grants selected based at least in part on the user equipment identifier and a quantity of the plurality of uplink grants, a second message that is a retransmission of the first message, the second message scrambled by the group identifier and comprising the user equipment identifier of the first UE.

Aspect 22: The method of any of aspects 16 through 21, wherein transmitting the first response message comprises: transmitting, via a shared channel, the first response message comprising the group identifier and a plurality of uplink grants; and receiving, during a first resource allocated by a randomly selected grant of the plurality of uplink grants, a second message that is a retransmission of the first message, the second message scrambled by the group identifier and comprising the user equipment identifier of the first UE.

Aspect 23: The method of any of aspects 16 through 22, wherein transmitting the first response message comprises: transmitting, via a shared channel, the first response message comprising the group identifier; and receiving, during a second uplink transmission resource of the plurality of uplink transmission resources, a second message that is a retransmission of the first message, the second message scrambled by the group identifier and comprising the user equipment identifier of the first UE.

Aspect 24: The method of any of aspects 16 through 23, wherein transmitting the first response message comprises: transmitting, via a shared channel, the first response message comprising the group identifier and a backoff indication, wherein the backoff indication indicates a first set of one or uplink transmission resources of the plurality of uplink transmission resources to refrain from transmitting; and receiving, during a second uplink transmission resource of the plurality of uplink transmission resources in accordance with the backoff indication, a second message that is a retransmission of the first message, the second message scrambled by the group identifier and comprising the user equipment identifier of the first UE.

Aspect 25: The method of any of aspects 16 through 24, wherein transmitting the first response message comprises: transmitting, via a shared channel, the first response message comprising the group identifier and a backoff indication, wherein the backoff indication comprises a codepoint to a table of backoff intervals; and receiving, during a second uplink transmission resource of the plurality of uplink transmission resources corresponding to a backoff interval from the table associated with the codepoint, a second message that is a retransmission of the first message, the second message scrambled by the group identifier and comprising the user equipment identifier of the first UE.

Aspect 26: The method of any of aspects 16 through 25, wherein receiving the first response message comprises: receiving, via a shared channel, the first response message comprising the group identifier, a plurality of uplink grants, and a backoff indication; and transmitting, during a resource allocated by a first uplink grant or in accordance with the backoff indication indicating to refrain from transmitting in at least one uplink transmission resource of the plurality of uplink transmission resources, a second message that is a retransmission of the first message, the second message scrambled by the group identifier and comprising the user equipment identifier of the first UE.

Aspect 27: The method of any of aspects 16 through 26, further comprising: transmitting the control message indicating a search space comprising a plurality of control channel candidates; and transmitting the first response message in a first control channel candidate of the plurality of control channel candidates based at least in part on transmitting the control message.

Aspect 28: The method of any of aspects 16 through 27, wherein receiving the first message comprises: receiving, in a MAC-CE, the user equipment identifier, wherein the first UE is in a connected state or an inactive state.

Aspect 29: The method of any of aspects 16 through 28, wherein receiving the first message comprises: receiving, in a MAC-CE, the first message, wherein the user equipment identifier of the first UE is derived based at least in part on a hash of a longer device identifier, and wherein the first UE is in an idle state.

Aspect 30: The method of any of aspects 16 through 29, wherein the group identifier corresponds to a group-RNTI and the user equipment identifier corresponds to a C-RNTI.

Aspect 31: An apparatus for wireless communication at a first UE, comprising a processor; memory coupled with the processor; and instructions stored in the memory and executable by the processor to cause the apparatus to perform a method of any of aspects 1 through 15.

Aspect 32: An apparatus for wireless communication at a first UE, comprising at least one means for performing a method of any of aspects 1 through 15.

Aspect 33: A non-transitory computer-readable medium storing code for wireless communication at a first UE, the code comprising instructions executable by a processor to perform a method of any of aspects 1 through 15.

Aspect 34: An apparatus for wireless communication at a base station, comprising a processor; memory coupled with the processor; and instructions stored in the memory and executable by the processor to cause the apparatus to perform a method of any of aspects 16 through 30.

Aspect 35: An apparatus for wireless communication at a base station, comprising at least one means for performing a method of any of aspects 16 through 30.

Aspect 36: A non-transitory computer-readable medium storing code for wireless communication at a base station, the code comprising instructions executable by a processor to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving a control message indicating a group identifier assigned to a group of UEs that includes the first UE and indicating a plurality of uplink transmission resources allocated to the group of UEs;
transmitting, during a first uplink transmission resource of the plurality of uplink transmission resources, a first message scrambled by the group identifier, wherein the first message comprises a user equipment identifier of the first UE; and
receiving a first response message comprising one of the group identifier or the user equipment identifier in response to transmitting the first message.

2. The method of claim 1, wherein receiving the first response message comprises:
receiving, via downlink control information, the first response message scrambled by the user equipment identifier in response to transmitting the first message.

3. The method of claim 1, wherein receiving the first response message comprises:
receiving, via a shared channel, the first response message scrambled by the group identifier in response to transmitting the first message.

4. The method of claim 3, further comprising:
transmitting a second message that is a retransmission of the first message based at least in part on receiving the first response message via the shared channel, the second message being scrambled by the group identifier and comprising the user equipment identifier of the first UE; and
receiving, via downlink control information, a second response message in response to transmitting the second message.

5. The method of claim 1, wherein receiving the first response message comprises:
receiving, via a shared channel, the first response message comprising the group identifier, a plurality of uplink grants, a backoff indication, or any combination thereof.

6. The method of claim 1, wherein receiving the first response message comprises:
receiving, via a shared channel, the first response message comprising the group identifier and a plurality of uplink grants; and
transmitting, during a first resource allocated by a first grant of the plurality of uplink grants selected based at least in part on the user equipment identifier and a quantity of the plurality of uplink grants, a second message that is a retransmission of the first message, the second message scrambled by the group identifier and comprising the user equipment identifier of the first UE.

7. The method of claim 1, wherein receiving the first response message comprises:
receiving, via a shared channel, the first response message comprising the group identifier and a plurality of uplink grants; and
transmitting, during a first resource allocated by a randomly selected grant of the plurality of uplink grants, a second message that is a retransmission of the first message, the second message scrambled by the group identifier and comprising the user equipment identifier of the first UE.

8. The method of claim 1, wherein receiving the first response message comprises:
receiving, via a shared channel, the first response message comprising the group identifier; and
transmitting, during a second uplink transmission resource of the plurality of uplink transmission resources, a second message that is a retransmission of the first message, the second message scrambled by the group identifier and comprising the user equipment identifier of the first UE.

9. The method of claim 1, wherein receiving the first response message comprises:
receiving, via a shared channel, the first response message comprising the group identifier and a backoff indication, wherein the backoff indication indicates a first set of one or more uplink transmission resources of the plurality of uplink transmission resources to refrain from transmitting; and
transmitting, during a second uplink transmission resource of the plurality of uplink transmission resources in accordance with the backoff indication, a second message that is a retransmission of the first message, the second message scrambled by the group identifier and comprising the user equipment identifier of the first UE.

10. The method of claim 1, wherein receiving the first response message comprises:
receiving, via a shared channel, the first response message comprising the group identifier and a backoff indication, wherein the backoff indication comprises a codepoint to a table of backoff intervals; and
transmitting, during a second uplink transmission resource of the plurality of uplink transmission resources corresponding to a backoff interval from the table associated with the codepoint, a second message that is a retransmission of the first message, the second message scrambled by the group identifier and comprising the user equipment identifier of the first UE.

11. The method of claim 1, wherein receiving the first response message comprises:
receiving, via a shared channel, the first response message comprising the group identifier, a plurality of uplink grants, and a backoff indication; and
transmitting, during a resource allocated by a first uplink grant or in accordance with the backoff indication indicating to refrain from transmitting in at least one uplink transmission resource of the plurality of uplink transmission resources, a second message that is a retransmission of the first message, the second message scrambled by the group identifier and comprising the user equipment identifier of the first UE.

12. The method of claim 1, further comprising:
receiving the control message indicating a search space comprising a plurality of control channel candidates;
monitoring the search space for the first response message; and
receiving the first response message in a first control channel candidate of the plurality of control channel candidates based at least in part on the monitoring.

13. The method of claim 1, wherein transmitting the first message comprises:
transmitting, in a medium access control (MAC) control element, the user equipment identifier, wherein the first UE is in a connected state or an inactive state.

14. The method of claim 1, wherein transmitting the first message comprises:
transmitting, in a medium access control (MAC) control element, the first message, wherein the user equipment identifier of the first UE is derived based at least in part on a hash of a longer device identifier, and wherein the first UE is in an idle state.

15. The method of claim 1, wherein the group identifier corresponds to a group-radio network temporary identifier and the user equipment identifier corresponds to a cell-radio network temporary identifier.

16. A method for wireless communication at a base station, comprising:
transmitting a control message indicating a group identifier assigned to a group of user equipments (UEs) that includes a first UE and indicating a plurality of uplink transmission resources allocated to the group of UEs;
receiving, from the first UE and during a first uplink transmission resource of the plurality of uplink transmission resources, a first message scrambled by the group identifier; and
transmitting, to the first UE, a first response message comprising one of the group identifier or a user equipment identifier indicated in the first message in response to transmitting the first message.

17. The method of claim 16, wherein transmitting the first response message comprises:
transmitting, via downlink control information, the first response message scrambled by the user equipment identifier in response to receiving the first message.

18. The method of claim 16, wherein transmitting the first response message comprises:
transmitting, via a shared channel, the first response message scrambled by the group identifier in response to receiving the first message.

19. The method of claim 18, further comprising:
receiving a second message that is a retransmission of the first message based at least in part on transmitting the first response message via the shared channel, the second message being scrambled by the group identifier and comprising the user equipment identifier of the first UE; and
transmitting, via downlink control information, a second response message in response to receiving the second message.

20. The method of claim 16, wherein transmitting the first response message comprises:
transmitting, via a shared channel, the first response message comprising the group identifier, a plurality of uplink grants, a backoff indication or any combination thereof.

21. The method of claim 16, wherein transmitting the first response message comprises:
transmitting, via a shared channel, the first response message comprising the group identifier and a plurality of uplink grants; and
receiving, during a first resource allocated by a first grant of the plurality of uplink grants selected based at least in part on the user equipment identifier and a quantity of the plurality of uplink grants, a second message that is a retransmission of the first message, the second message scrambled by the group identifier and comprising the user equipment identifier of the first UE.

22. The method of claim 16, wherein transmitting the first response message comprises:
transmitting, via a shared channel, the first response message comprising the group identifier and a plurality of uplink grants; and
receiving, during a first resource allocated by a randomly selected grant of the plurality of uplink grants, a second message that is a retransmission of the first message, the second message scrambled by the group identifier and comprising the user equipment identifier of the first UE.

23. The method of claim 16, wherein transmitting the first response message comprises:
transmitting, via a shared channel, the first response message comprising the group identifier; and
receiving, during a second uplink transmission resource of the plurality of uplink transmission resources, a second message that is a retransmission of the first message, the second message scrambled by the group identifier and comprising the user equipment identifier of the first UE.

24. The method of claim 16, wherein transmitting the first response message comprises:
transmitting, via a shared channel, the first response message comprising the group identifier and a backoff indication, wherein the backoff indication indicates a first set of one or uplink transmission resources of the plurality of uplink transmission resources to refrain from transmitting; and
receiving, during a second uplink transmission resource of the plurality of uplink transmission resources in accordance with the backoff indication, a second message that is a retransmission of the first message, the second message scrambled by the group identifier and comprising the user equipment identifier of the first UE.

25. The method of claim 16, wherein transmitting the first response message comprises:
transmitting, via a shared channel, the first response message comprising the group identifier and a backoff indication, wherein the backoff indication comprises a codepoint to a table of backoff intervals; and
receiving, during a second uplink transmission resource of the plurality of uplink transmission resources corresponding to a backoff interval from the table associated with the codepoint, a second message that is a retransmission of the first message, the second message scrambled by the group identifier and comprising the user equipment identifier of the first UE.

26. The method of claim 16, wherein receiving the first response message comprises:
receiving, via a shared channel, the first response message comprising the group identifier, a plurality of uplink grants, and a backoff indication; and
transmitting, during a resource allocated by a first uplink grant or in accordance with the backoff indication indicating to refrain from transmitting in at least one uplink transmission resource of the plurality of uplink transmission resources, a second message that is a retransmission of the first message, the second message scrambled by the group identifier and comprising the user equipment identifier of the first UE.

27. The method of claim 16, further comprising:
transmitting the control message indicating a search space comprising a plurality of control channel candidates; and
transmitting the first response message in a first control channel candidate of the plurality of control channel candidates based at least in part on transmitting the control message.

28. The method of claim 16, wherein receiving the first message comprises:
receiving, in a medium access control (MAC) control element, the user equipment identifier, wherein the first UE is in a connected state or an inactive state.

29. An apparatus for wireless communication at a first user equipment (UE), comprising:
a processor;
memory coupled with the processor; and
instructions stored in the memory and executable by the processor to cause the apparatus to:
receive a control message indicating a group identifier assigned to a group of UEs that includes the first UE and indicating a plurality of uplink transmission resources allocated to the group of UEs;
transmit, during a first uplink transmission resource of the plurality of uplink transmission resources, a first message scrambled by the group identifier, wherein the first message comprises a user equipment identifier of the first UE; and
receive a first response message comprising one of the group identifier or the user equipment identifier in response to transmitting the first message.

30. An apparatus for wireless communication at a base station, comprising:
a processor;
memory coupled with the processor; and
instructions stored in the memory and executable by the processor to cause the apparatus to:
transmit a control message indicating a group identifier assigned to a group of user equipments (UEs) that includes a first UE and indicating a plurality of uplink transmission resources allocated to the group of UEs;
receive, from the first ULE and during a first uplink transmission resource of the plurality of uplink transmission resources, a first message scrambled by the group identifier; and
transmit, to the first UE, a first response message comprising one of the group identifier or a user equipment identifier indicated in the first message in response to transmitting the first message.
